(19) United States
(12) Patent Application Publication
(10) Pub. No.: US 2024/0368049 A1
(43) Pub. Date: Nov. 7, 2024

(54) ENHANCED PHYTOREMEDIATION FROM BIOAVAILABILITY OF PER- AND POLYFLUOROALKYL SUBSTANCES IN CONTAMINATED SOIL

(71) Applicant: The Research Foundation for the State University of New York, Albany, NY (US)

(72) Inventors: Yanna Liang, Albany, NY (US); Weilan Zhang, Albany, NY (US)

(21) Appl. No.: 18/655,578

(22) Filed: May 6, 2024

Related U.S. Application Data
(60) Provisional application No. 63/464,243, filed on May 5, 2023.

(51) Int. Cl. C05G 3/80; C05D 9/00; C05G 3/50

(52) U.S. Cl. CPC C05G 3/80; C05D 9/00; C05G 3/50

(57) ABSTRACT

A method for enhanced phytoremediation by changing bioavailability of per- and polyfluoroalkyl substances (PFAS) to plants in biosolids amended soil through stabilization or mobilization. A mobilizing reagent can be added at a predetermined dose, to amend the soil around a root system of one or more plants, and the amended soil can also be supplemented with a stabilizing reagent at a predetermined dose to change the bioavailability of (PFAS) to one or more plants in the amended soil. Through adjustment of the mobilizing reagent and stabilizing reagent, the uptake of PFAS by the one or more plants can be selectively increased or decreased.

### CROSS-REFERENCE TO RELATED APPLICATION

This application claims the benefit of U.S. Provisional Patent Application No. 63/464,243, filed on May 5, 2023, the entirety of which is hereby incorporated herein by this reference.

### BACKGROUND OF THE INVENTION

### 1. Field of the Invention

The present invention generally relates to the removal of per- and polyfluoroalkyl substances (PFAS) from soil. More particularly, the present invention is for a system and method for enhanced phytoremediation by changing bioavailability of PFAS substances (PFAS) to plant in biosolids amended soil through stabilization or mobilization.

### 2. Description of the Related Art

Per- and polyfluoroalkyl substances (PFAS) are a group of chemicals consisting of thousands of synthetic organic compounds in which the hydrogen atoms bound to the carbon backbones are fully or partially substituted with fluorine. The unique properties of PFAS have enabled their great use in numerous industrial processes and commercial products, including mining and oil well surfactants, coatings for textiles and food packaging, firefighting foams, cosmetics and personal care, cleaning agents, and many others. The wide usage of PFAS has resulted in their broad distribution and possible adverse effects on the environment. They have been reported to occur in various environmental matrices, such as surface waters, rainwater, ground water, indoor and outdoor air, household dust, sediments, sewage sludge, and soil.

PFAS have been manufactured for over sixty years and because they are now detected ubiquitously, PFAS attract growing concerns due to the risks to human health and the environment associated with their presence, frequency of occurrence, and sources of contamination. PFAS can be bioaccumulative in the environment and also undergo biomagnification. PFAS have been identified as persistent organic pollutants (POPs) with estimated half-lives of up to 8.5 years, with detection in blood sera of a wide variety of living creatures, such as humans, cattle, minks, otters, marine mammals, birds, fish, and mussels. Various studies have demonstrated acute, subacute, subchronic, chronic, and developmental toxicities of PFAS to animals. Recently, the U.S. EPA dramatically lowered the lifetime health advisory levels in drinking water for the two legacy PFAS in the U.S.—perfluorooctanoic acid (PFOA) and perfluorooctanesulfonic acid (PFOS), from the previous 70 parts per trillion (ppt) to 0.004 ppt for PFOA and 0.02 ppt for PFOS (USEPA 2022). Additionally, the EPA issued final health advisories for two PFOA and PFOS alternatives, namely undecafluoro-2-methyl-3-oxahexanoic acid (GenX) and perfluorobutane sulfonic acid (PFBS), in drinking water (USEPA 2022).

Due to the remarkably high energy of carbon-fluorine bonds (the strongest existing covalent bond with 450 kJ/mol), PFAS are resistant to thermal, chemical, and biological decomposition, leading to their extreme stability and persistence. Thus, destruction of PFAS is extraordinarily difficult as it requires intensive energy consumption and extant efforts of PFAS destruction are often ineffective.

High concentrations of perfluoroalkyl acids (PFAAs) have been observed in sewage sludge particles. Given the ubiquitous detection of PFAS in sewage sludge and biosolids, land application of these materials inevitably leads to contamination of the receiving environment. Although U.S. EPA does not have regulations regarding PFAS in biosolids for land application, regulatory actions are in progress. Current, the Maine Department of Environmental Protection (DEP) requires PFAS testing of all sludge material licensed for land application and the screening levels of PFBS, PFOS, and PFOA in solid waste for beneficial use, including sludge and biosolids, are 1900 μg/kg, 5.2 μg/kg, and 2.5 μg/kg, respectively. It is known that plants can uptake and accumulate PFAS in roots and shoots, which then obviously leads to contamination of the food chain. Thus, it is urgent to identify approaches that can decrease bioavailability of PFAS in biosolids that are amended to soil.

Phytoremediation aims to use plants to extract and remove pollutants in contaminated environments. It has been demonstrated that plants, including Juncus effusus (soft rush), Typha latifolia (cattail), Carex comosa (longhair sedge), and Lemna minor (duckweed), can be utilized to reduce PFAS concentrations in contaminated water and soil. The PFAS removal by plants was found to be strongly and positively correlated with PFAS' water solubility or hydrophilicity.

Therefore, it would be advantageous to provide a natural solution to uptake PFAS from a polluted environment, such as soil. It is to such problem that the present invention is primarily directed.

### BRIEF SUMMARY OF THE INVENTION

Phytoremediation has been proven to be effective for removing per- and polyfluoroalkyl substances (PFAS) from various environmental matrices, for example soil, sediment, groundwater and surface water. Different plant species have different natural capabilities with regard to uptaking PFAS from these matrices. The natural capabilities of the plant can be engineered to either enhance or decrease plant uptake of PFAS.

This engineered enhanced uptake can be done with a combination of actions. First, adding a mobilizing reagent, such as a surfactant at a suitable dose can promote plant uptake of PFAS. Second, supplementing a stabilizing reagent at a proper dose can decrease translocation of PFAS by a plant species. Third, seeds harvested from a plant exposed to PFAS can be grown again to increase uptake of certain PFAS.

These strategies can be done individually or coupled together to achieve different purposes. For instance, if fast removal of PFAS from a contaminated site is desired, then growing PFAS containing seeds at the site amended with a mobilizing reagent could be adopted. In another case, at agricultural land, if PFAS uptake by plants needs to be minimized, then a stabilizing reagent can be supplemented to the soil. Under this scenario, the plants can still grow normally and yield non-contaminated grains, fruits and vegetables, but will not take up PFAS since the PFAS are fixed in the soil.

Briefly described, the present invention includes methods for enhanced phytoremediation by changing bioavailability of per- and polyfluoroalkyl substances (PFAS) to plants in biosolids amended soil through stabilization or mobilization. A mobilizing reagent can be added at a predetermined dose, to amend the soil around a root system of one or more plants, and the amended soil can also be supplemented with a stabilizing reagent at a predetermined dose to change the bioavailability of (PFAS) to one or more plants in the amended soil. Through adjustment of the mobilizing reagent and stabilizing reagent, the uptake of PFAS by plants can be selectively increased or decreased.

The immobilization/stabilization approach strives to hold pollutants in their original environment while restricting their transport to the surrounding locations has been demonstrated to be effective for remediating PFAS contaminated soil. Biochar, granular activated carbon (GAC), clay minerals, and some commercial products such as RemBind® and FLUORO-SORB® have been tested as sorbents to stabilize PFAS in soil and showed promising performance.

In one embodiment, the uptake and bioaccumulation of PFAS by soybeans can be engineered under different conditions. Soybean can take up perfluo-rooctanoic acid (PFOA) and perfluorooctanesulfonic acid (PFOS) from biosolids-amended soil and bioaccumulated these PFAS in plant roots and shoots. The concentrations of PFOA and PFOS in soybean roots will correlate positively with root protein contents while negatively with root lipid contents. Perfluorooctane sulfonamide (FOSA), a PFAS precursor, can be bioavailable to soybean in a hydroponic system and could be metabolized to PFOS, perfluorohexane sulfonate (PFHxS), and perfluorobutanesulfonic acid (PFBS) during the process of plant uptake. Plant uptake and biotransformation of another PFAS precursor, 8:2 fluorotelomer alcohols (8:2 FTOH), can also occur in soybean. Of concern with soybean, the edible seeds are economically one of the most important food groups in the world, providing vegetable protein and other essential nutrients for humans. PFAS presence in soybean seeds accordingly raises health concerns due to their persistent and toxic properties. Therefore, the present invention can be utilized to minimize PFAS uptake in certain plants, such as soybean.

The present invention is therefore advantageous as it can effectively remove PFAS from soil, as well as limit the uptake of PFAS in certain plants. Furthermore, the present invention has industrial applicability in that it can be used to limit PFAS adsorption in certain plants, such as soybean. These and other advantages of the present invention will become apparent to one of skill in the art after review of the present application.

### BRIEF DESCRIPTION OF THE DRAWINGS

FIG. 1 is a series of graphs of concentrations of PFAS in timothy-grass shoots grown in biosolids-amended soil treated by different sorbents.

FIG. 2 is series of graphs of Levels of chlorophyll a, chlorophyll b and total chlorophyll in timothy-grass shoots.

FIG. 3 is a series of graphs of percentages of leachable PFAS in biosolids-amended soil treated by different sorbents.

FIG. 4 is a series of graphs of concentrations of PFAS in timothy-grass shoots grown in biosolids-amended soil treated by SDS.

FIG. 5 is a graph of concentrations of PFAS in the seeds of the first-generation soybean plants.

FIG. 6 is a series of graphs of the concentrations of PFOA or PFOS in the shoots and roots of the first- and second-generation soybean plants.

FIG. 7 is a series of graphs of concentrations of PFAS in the shoots and roots of the first- and second-generation soybean.

FIG. 8 is a series of graphs of root concentration factors (RCF) and translocation factors (TF) of PFOA or PFOS in first- and second-generation plants.

FIG. 9 is a series of graphs of root concentration factors (RCF) and translocation factors (TF) of PFAS in first- and second-generation plants.

FIG. 10 is a series of graphs of the percentages of PFAS removal from soil by first- and second-generation soybean plants.

### DETAILED DESCRIPTION OF THE INVENTION

To control the environmental and health risks led by PFAS in biosolids amended to soil, one can (1) add a sorbent to biosolids can decrease plant uptake of per- and polyfluoroalkyl substances (PFAS) to plants in amended soil, while (2) adding a surfactant to biosolids can increase plant uptake of PFAS. The present inventive method demonstrates this ability and timothy-grass (Phleum pratense) was selected as one plant for demonstration. It is an abundant perennial grass native to Europe and was introduced to North America by early settlers. Currently, timothy-grass is a major source of hay and cattle fodder. Previous reports also demonstrated the capability of timothy-grass for phytoremediation of heavy metal contaminated soil. To test the hypothesis, the uptake of PFAS by timothy-grass grown in soil amended by biosolids that was treated by a sorbent (i.e., biochar, GAC, or RemBind®) or an anionic surfactant (i.e., sodium dodecyl sulphate (SDS)) was investigated. The present invention demonstrates the feasibility of controlling bioavailability of PFAS in the biosolids-soil-grass system through a stabilization or mobilization approach.

The method uses the addition of a mobilizing reagent, at a predetermined dose as described herein, to amend the soil around a root system of one or more plants. The supplementing of the amended soil with a stabilizing reagent at a predetermined dose, as also defined below. In one embodiment, the preparation of biosolids amended soil uses a sandy loam soil used in this study (pH=7.56), which was collected from a local farm in Albany County, New York. The soil was passed through a 2-mm sieve before use. The contents of natural organic matter and total organic carbon of the sieved soil were 4.82±0.12% and 2.44±0.45%, respectively. The sieved soil was mixed with vermiculite in a 1:1 vol ratio for increasing water retention of the soil and improving soil aeration. Then, the processed soil for plant cultivation was distributed to 7-quart polypropylene containers (14.375″L×8.25″W×6″H). Each container had 1.3 kg of dry soil.

The biosolids after anaerobic digestion of sludge were collected from a nearby wastewater treatment plant close to University at Albany. The total solid and total organic carbon of the biosolids were 24.16±0.21% and 28.64±0.28%, respectively. Ten PFAS, including perfluorobutanesulfonic acid (PFBS), perfluorohexanoic acid (PFHxA), undecafluoro-2-methyl-3-oxahexanoic acid (GenX), perfluoroheptanoic acid (PFHpA), perfluorohexane sulfonate (PFHxS), perfluorooctanoic acid (PFOA), perfluorononanoic acid (PFNA), perfluorooctanesulfonic acid (PFOS), perfluorodecanoic acid (PFDA), and perfluoroundecanoic acid (PFUnA), were added to and homogenized with the biosolids, reaching the target concentration of each PFAS at 300 μg/kg dry biosolids. The mixture was then stored at 4° C. for 7 days. Afterwards, the PFAS spiked biosolids were homogenized with one sorbent (biochar, GAC, or RemBind) at 0.2 or 2 wet wt. % or a surfactant, SDS, at 10, 50 or 100 mg/kg. The biochar (Biochar Supreme, LLC, Everson, WA) was derived from forest wood waste and contained over 85% of organic carbon with a specific surface area of ˜800 m2/g. The size of the GAC (Alfa Aesar, Ward Hill, MA) ranged from 425 μm to 850 μm with a specific surface area of ˜650 m2/g. The porosity and density of the GAC were around 0.78 and 2.26 g/cm3, respectively. RemBind was gifted from AquaBlok Ltd as a distributor for RemBind® (Australia). After aging for 7 days, the biosolids with a sorbent or a surfactant were thoroughly mixed with the prepared soil at a ratio of 0.17 kg biosolids/kg of dry soil. This ratio is equivalent to 5 dry ton biosolids/acre of soil recommended by US EPA for biosolids land application. Based upon the TS of the biosolids and the spiked PFAS concentrations, there were 55.56 g of dry biosolids and 16.67 μg of each spiked PFAS in each container with 1.3 kg of dry soil.

Two sets of controls were set up as well: (1) soil amended with the original biosolids without PFAS spiking, sorbents, or surfactants (non-spiked control); (2) soil amended with PFAS spiked biosolids without any sorbents or surfactants (spiked control). Three replicates were prepared for each control and treatment.

Timothy-grass seeds were purchased from OrOlam LLC (South Miami, FL). One gram of seeds was sown evenly in each tank containing the prepared biosolids amended soil. Enough water was then added to each tank to reach 100% of field capacity. The plants were cultivated in a greenhouse and watered every day. The timothy-grass started germinating on the 5th day after sowing. On Day-40 after seed germination, the above-ground shoots of the grass in each tank were cut and rinsed thoroughly using deionized water. Around 1 g of the plant tissues from each treatment was used for chlorophyll extraction and quantification. The remaining plant shoots were freeze-dried at −37° C. for 48 h and subject to PFAS extraction and analysis. The plants after cutting were kept under the same growth condition. On Day-80 after seed germination or day-40 after the first cut, the plant shoots were removed again and subject to chlorophyll and PFAS analysis. The soil in each tank was then kept under a fume hood for air drying. After 2 weeks, the dried soil was crushed into fine particles and thoroughly homogenized by using a glass rod. Representative soil samples were collected for PFAS analysis.

On Day-40 and Day-80 after seed germination, 100 mg of fresh grass leaves were collected and used to quantify chlorophyll content. The leaf tissues were placed in a 15-mL glass tube with 10 mL of 90% acetone. After 48 h, the chlorophyll concentration in the solvent was determined using a UV-Vis spectrophotometer (GENESYS 10S, Thermo Fisher Scientific, altham, MA, USA). The absorbance was read at 664 and 647 nm and used to calculate chlorophyll a and b and total chlorophyll content according to these equations:

$$\\ Chl \text{?} ( mg / L ) = 12.72 OD \text{?} - 2.59 OD \text{?}$$

$$\\ Chl \text{?} ( mg / L ) = 22.9 OD \text{?} - 4.67 OD \text{?}$$

$$\\ Chl \text{?} ( mg / L ) = Chl \text{?} + Chl \text{?} = 20.31 OD \text{?} - 8.05 OD \text{?}$$

$$\\ \text{?} \text{indicates text missing or illegible when filed}$$

PFAS in the freeze-dried timothy-grass shoots were extracted by MTBE-NaOH according to a previously developed method. Before extraction, each sample for extraction was spiked with 10 ng of 13C2-PFHxA as the surrogate for determining the extraction efficiency. EPA method 1312 (Synthetic Precipitation Leaching Procedure, SPLP) was performed on the biosolids amended soil after drying to determine the leachability of PFAS. Briefly, 20 mL of H2SO4/HNO3 reagent (60/40 wt/wt.) at pH=4.2 were added to the soil sample. The soil with the H2SO4/HNO3 reagent was then vortexed for 30s and shaken on an end over end mixer overnight. After centrifugation at 3500 g for 30 min, the supernatant was collected and subject to solid phase extraction (SPE) using HyperSep C18 cartridges (Thermo Scientific, Waltham, MA). The SPLP leachable PFAS on the C18 cartridges were eluted with 2 mL of methanol, followed by 2 mL of 0.1% NH40H amended methanol. The SPLP leachable PFAS in clean soil without biosolids amendment were analyzed as well. PFAS in the final plant extracts and SPLP leachates were quantified using a 1290 Infinity II LC system coupled with a 6470 Triple Quad Mass Spectrometer (LC-MS/MS, Agilent Technologies, Santa Clara, CA, USA).

The experimental data are presented as means±the standard deviation of three replicates. One-way analysis of variance and Tukey's test for post hoc comparisons were performed with IBM SPSS Statistics 22. Statistical significance was defined as p<0.05.

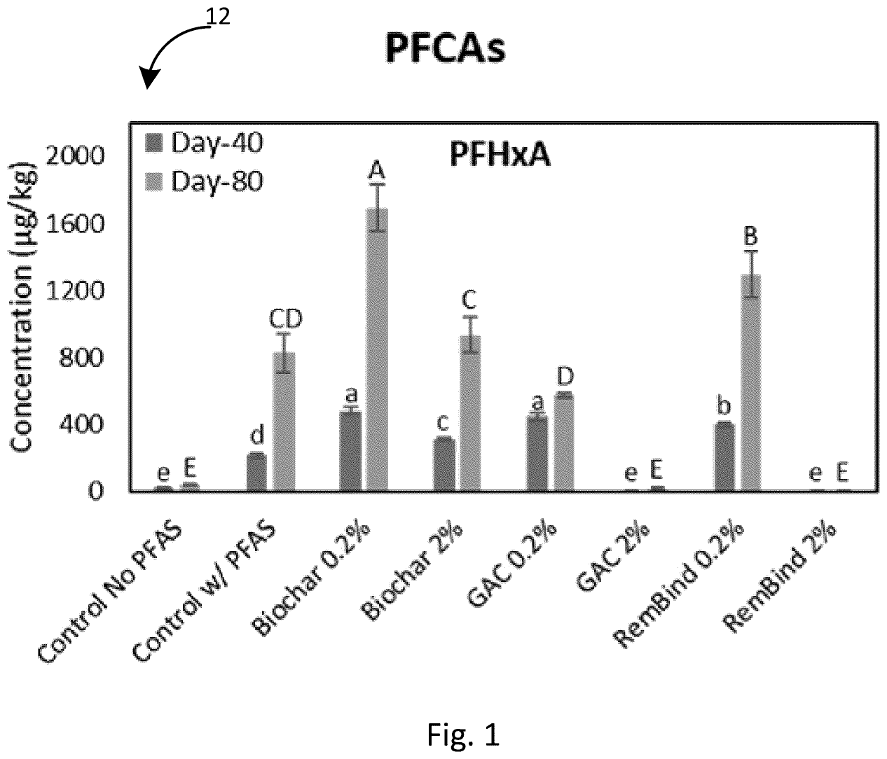

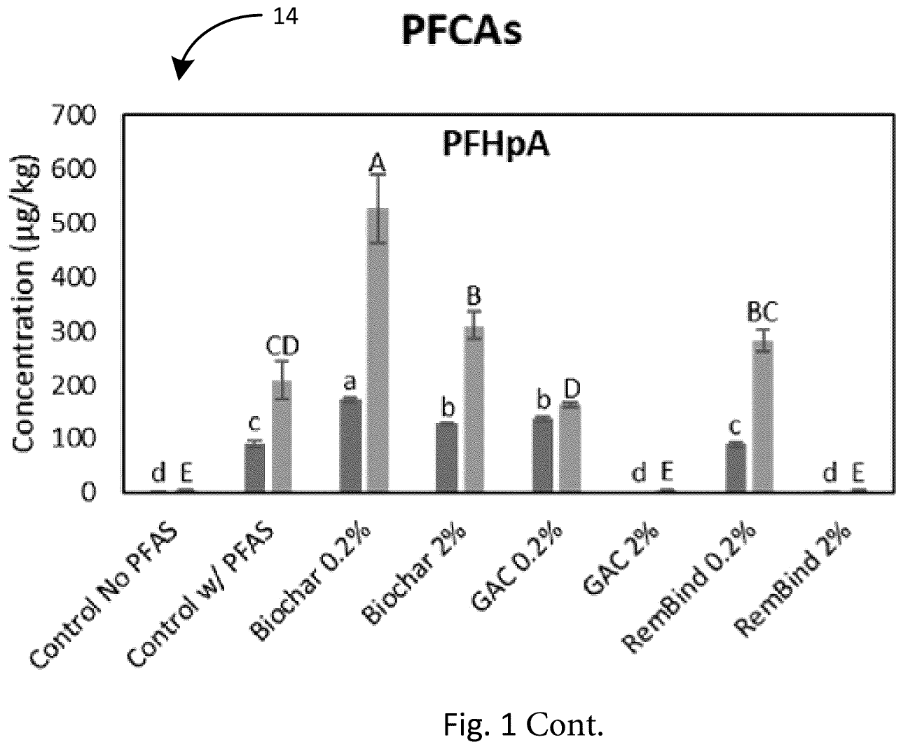

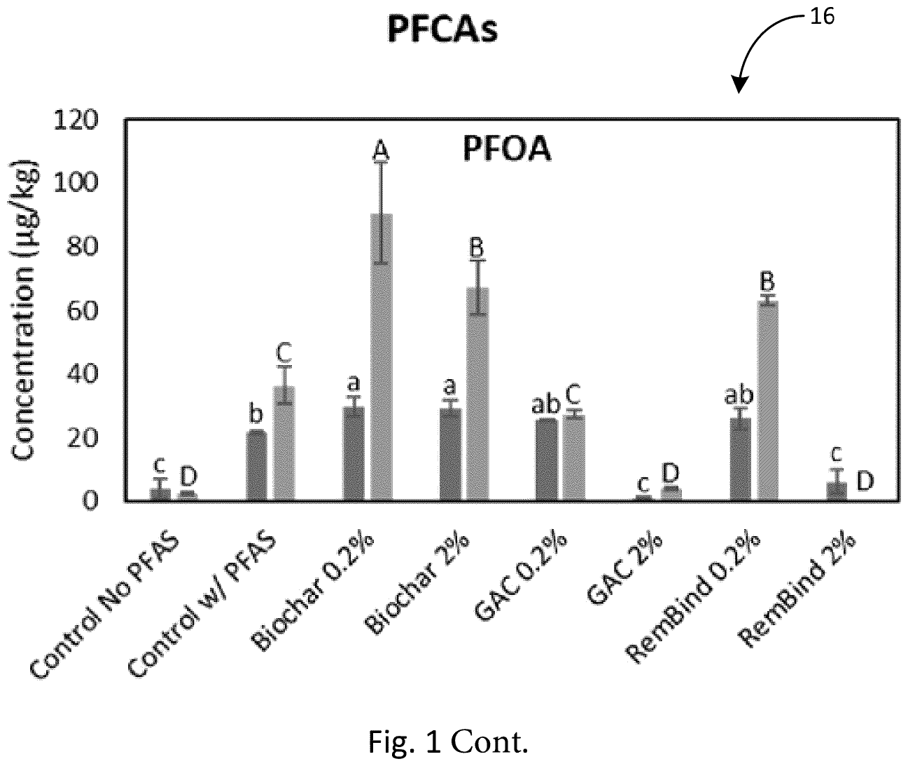

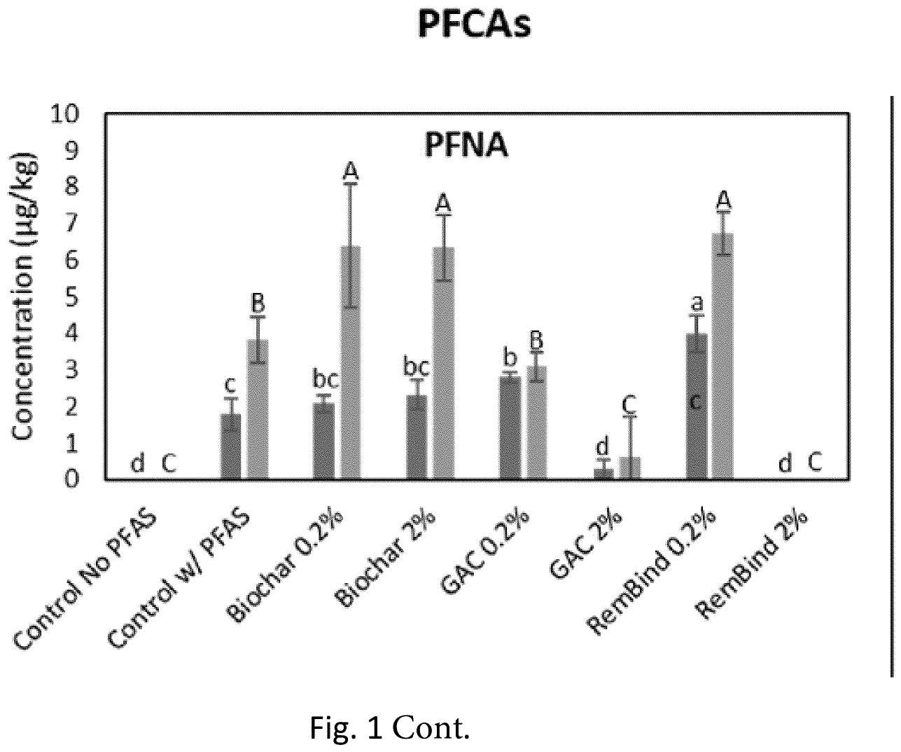

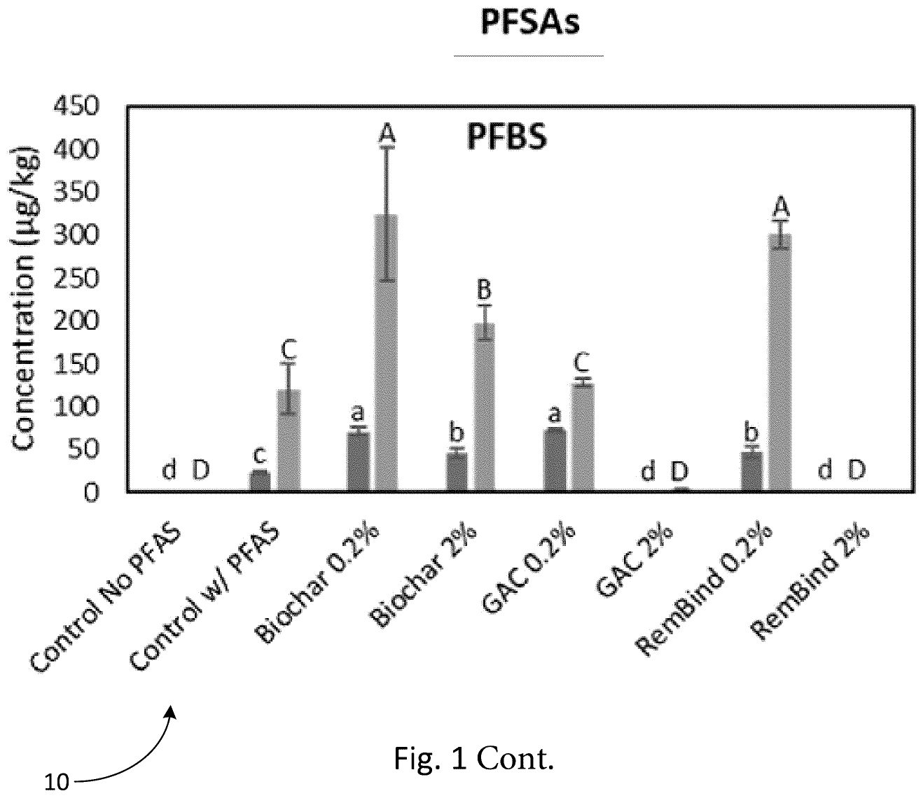

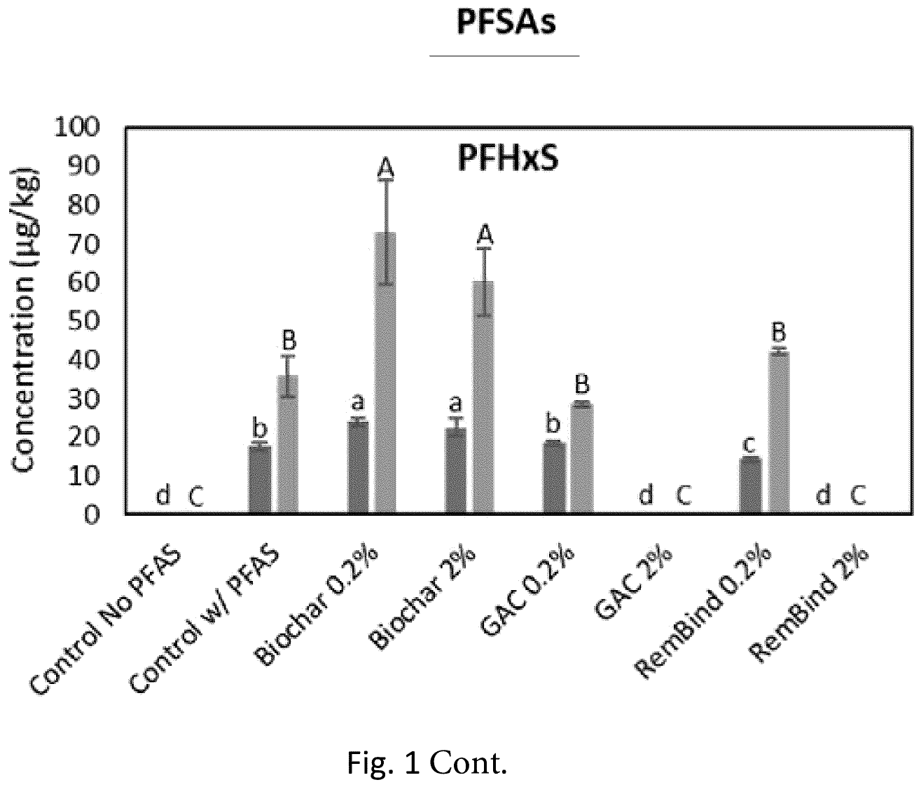

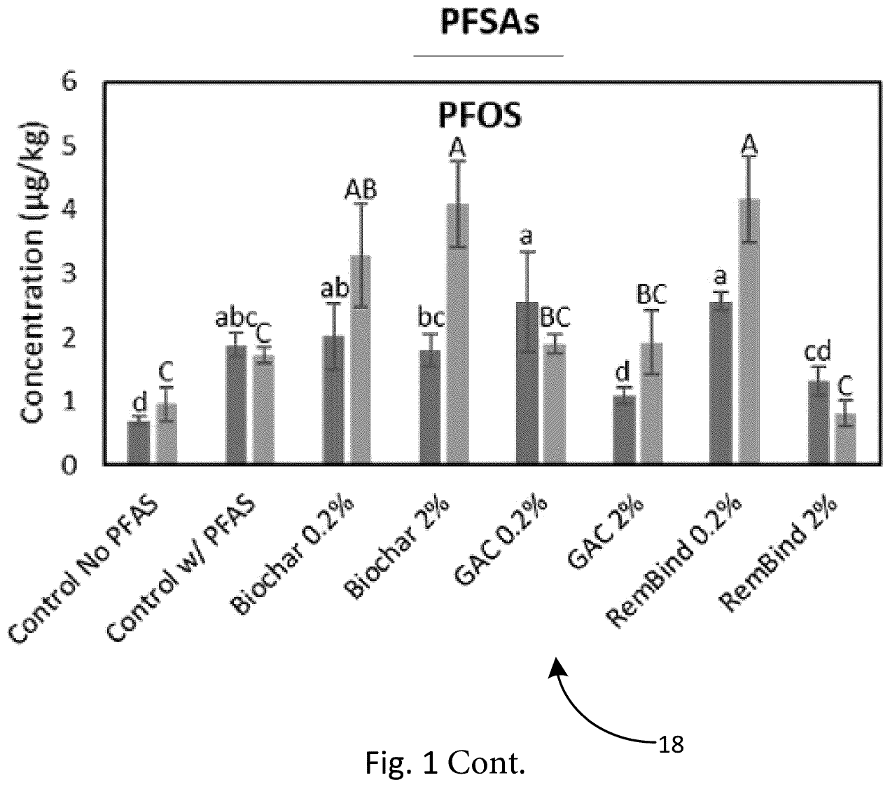

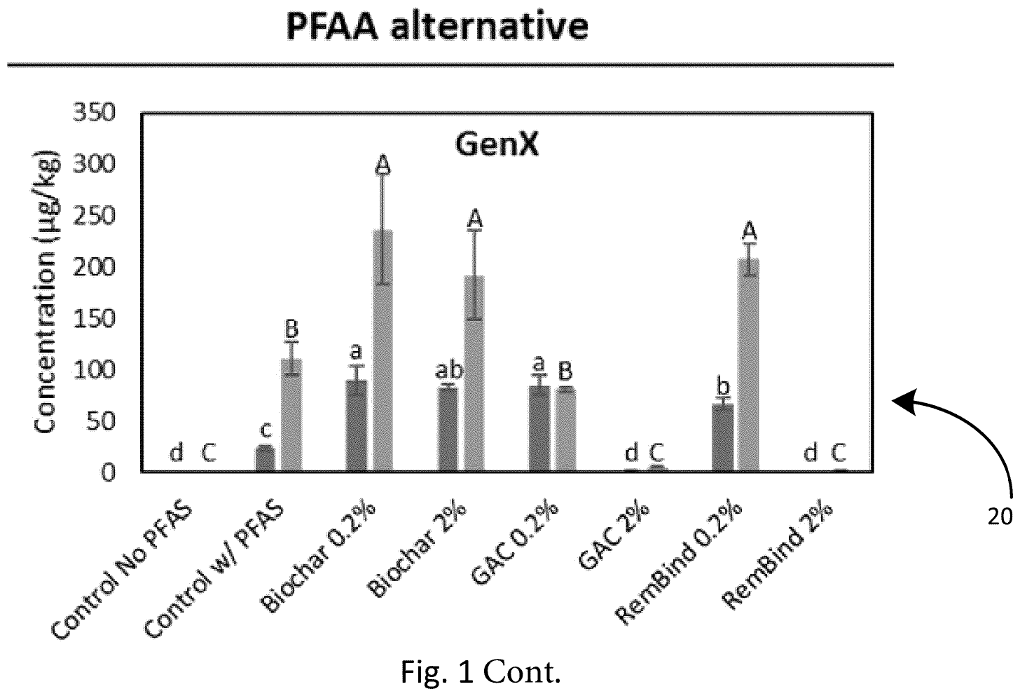

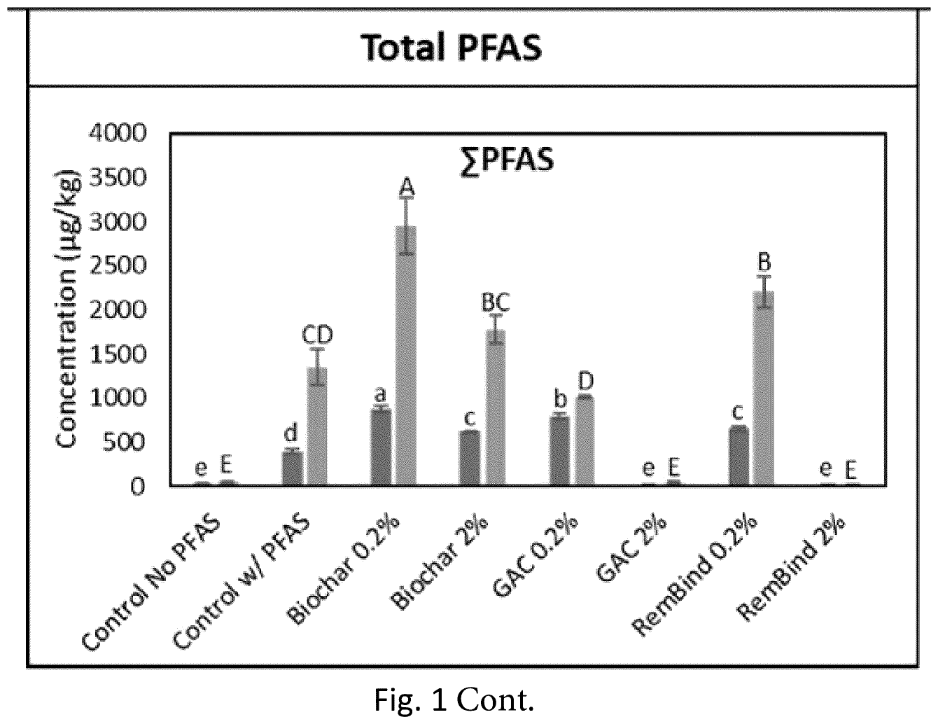

FIG. 1 is a series of graphs 10 of concentrations of PFAS in timothy-grass shoots grown in biosolids-amended soil treated by different sorbents on Day-40 and Day-80 (n=3). PFDA and PFUnA were not detected in timothy-grass shoots. Different letters in lower case and upper case represent significant differences among the treatments (p<0.05). As shown in FIG. 1, for the soil amended with the biosolids but without PFAS addition (non-spiked control), PFHxA 12, PFHpA 14, PFOA 16, and PFOS 18 at 24.70±1.46, 1.96±0.29, 3.89±2.90, and 0.70±0.05 μg/kg, respectively, was detected in shoots on Day-40. The presence of the same PFAS in grass shoots on Day-80 was also detected. The studied PFAS in the pristine soil without biosolids amendment were non-detectable.

Thus, the source of these PFAS should be the biosolids used in this study. This biosolids is known to comprise PFAS as we previously reported. In the same biosolids, PFOS had the highest concentration of 10 μg/kg, while the concentration of PFHxA, PFHpA and PFOA was around 1-5 μg/kg. Unsurprisingly, amending soil with biosolids spiked with PFAS at 300 μg/kg but without a sorbent or a surfactant (spiked control) resulted in significantly higher PFAS concentrations in grass shoots compared to the non-spiked control. All spiked PFAS except PFDA and PFUnA were taken up by timothy-grass. There was an obvious trend that the uptake of PFCAs and PFSAs in the shoots decreased with increasing carbon chain length. Among PFCAs, PFHxA had the highest concentration in shoots on Day-40 (217.23±16.95 μg/kg), followed by PFHpA (90.66±6.74 μg/kg), PFOA (21.73±0.59 μg/kg), and PFNA (1.79±0.44 μg/kg).

When the carbon chain length was higher than 8, such as PFDA and PFUnA, the upward translocation was non-detectable. Similarly, PFBS at 23.61±1.90 μg/kg had the highest concentration in shoots among PFSAs, followed by PFHxS (17.61±0.88 μg/kg) and PFOS (1.88±0.19 μg/kg). PFCAs had significantly higher concentrations than PFSAs in plants when their carbon chain length was the same. This is in line with numerous studies that have demonstrated the effect of PFAS chain length and functional group on plant uptake.

With sorbents at different doses, the bioavailability of PFAS in the biosolids amended soil varied significantly. On Day-40, biochar at both doses did not show any PFAS stabilization effect when compared to the spiked controls. Instead, it notably increased the plant uptake of PFAS, especially at the lower dose of 0.2%. The total PFAS concentration (ΣPFAS) 20 in grass shoots grown in biosolids amended soil treated by biochar at 0.2% and 2% was 120.03% and 56.99% higher than that of the spiked control. Such enhancement of plant uptake of PFAS was also observed in soil with biosolids treated by 0.2% of GAC and RemBind, a sorbent containing activated carbon, aluminum oxyhydroxide, and clay minerals.

Biochar has been investigated for PFAS stabilization in soil previously. Hydrophobic interaction and intra-particle diffusion were proposed to be the main mechanisms for PFAS adsorption onto biochar. We also reported that biochar largely decreased the water and SPLP leachable PFAS with long carbon chains in soil. However, in sewage sludge spiked with PFAS at 30 or 300 μg/kg, the same biochar at a dose of 2% showed a limited reduction of leachable PFAS. The different compositions and characteristics between soil and biosolids could explain the different performance of biochar in these two materials. Biochar is commonly used as a soil amendment to alter soil structure and increase soil porosity and water-holding capacity.

Adding biochar to soil could provide a more hospitable environment for soil microorganisms and facilitate plant uptake of air, water, and nutrients, possibly leading to the increased uptake of PFAS by timothy-grass. Similar beneficial effect on plants was also observed for soil amended with GAC. Others have found that carbonaceous sorbent such as biochar and GAC at 3% in soil had a positive effect on the growth of maize in terms of chlorophyll content and plant biomass. Others also have reported that GAC amendment at 2% in soil increased growth rate of squash and carrot. There is no evidence in the literature showing the positive effects of RemBind on plants. RemBind at high dose (5-30%) was even reported to decrease the biomass of wheatgrass and the weight of earthworms in treated soil. The adverse effect of RemBind was proposed to be due to the sorption of essential nutrients in soil to this sorbent. The dose used in this study was based on the dry weight of biosolids. The overall weight percent of RemBind in the biosolids-amended soil at 0.2% was even lower. Thus, we speculated that GAC and RemBind at 0.2% in biosolids could also increase the water and nutrients uptake, leading to higher PFAS bioaccumulation in grass shoots compared to no-sorbent controls.

At the higher dose (i.e., 2%), GAC and RemBind significantly reduced the bioavailability of PFAS in biosolids-amended soil. The ΣPFAS concentration 20 in grass shoots grown in biosolids amended soil treated by GAC or RemBind at 2% was only 2.77% and 3.35% of the ΣPFAS concentration detected in shoots in the spiked control, respectively. This is in line with previous observation that GAC and RemBind at 2% had excellent performance regarding stabilizing PFAS in sludge. Strong stabilization performance of decreasing 99% of water and SPLP leachable PFAS by GAC and RemBind in soil was also reported. Thus, it appears that the effect of sorption of PFAS to GAC or RemBind surpassed the potential enhancement of plant uptake led by the amendment of a sorbent. Considering the high complexity of the tested system, it is difficult to pinpoint exactly the reasons or mechanisms controlling the results we observed. Further in-depth investigations on the effects of biochar/GAC/RemBind on plant physiology and biochemistry are needed to elucidate the mechanisms underlying the decreased or enhanced uptake of PFAS in the presence of carbon-based sorbents at different doses.

Here, the timothy-grass was cut about 1 inch above the soil surface on Day-40 after germination. Afterwards, the grass was allowed to grow to a similar height on Day-80 and was subject to PFAS analysis again. For these Day-80 shoots, a similar PFAS uptake pattern was observed as those harvested on Day-40. Basically, compared to the spiked controls without a sorbent, GAC and RemBind at 0.2% and biochar at both 0.2% and 2% led to significant increase of plant uptake of PFAS, while GAC and RemBind at 2% reduced over 99% of PFAS concentration in grass shoots. It should be noted that the concentrations of all studied PFAS on Day-80 (light bars in FIG. 1) were significantly higher than their counterparts on Day-40 (dark bars in FIG. 1), which hinted higher rate of PFAS uptake during the second 40 days than the first 40 days. This is in agreement with reports demonstrating that proper mowing could promote the water consumption and regrowth of grasses. Similarly, the PFAS removal from biosolids amended soil by timothy-grass shoots during the second 40 days was significantly higher than that during the first 40 days. After 80 days of cultivation, the total removal of ΣPFAS from biosolids amended soil, which was the sum of ΣPFAS removal on Day-40 and Day-80, in spiked control was 5.03±0.68%. Treating biosolids with biochar at 0.2% led to the highest total removal of ΣPFAS by timothy-grass shoots, reaching 9.11±0.85%. GAC and RemBind at 2% decreased the total removal of ΣPFAS to 0.14±0.01% and 0.08±0.02%, respectively. Overall, RemBind at 2% had the best stabilization performance after 80 days of plant growth, while biochar at 0.2% had the worst performance regarding PFAS stabilization.

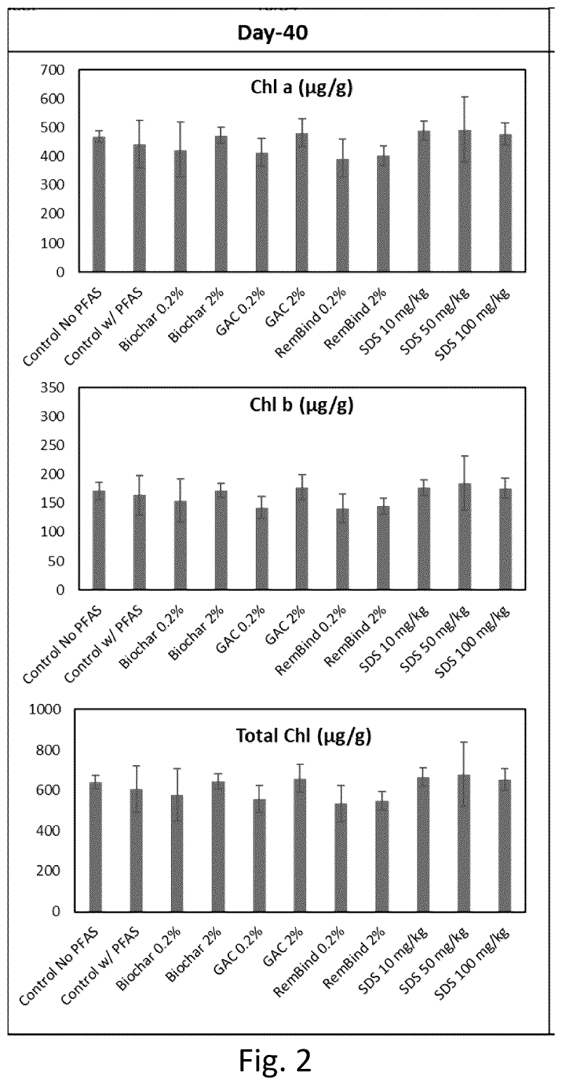

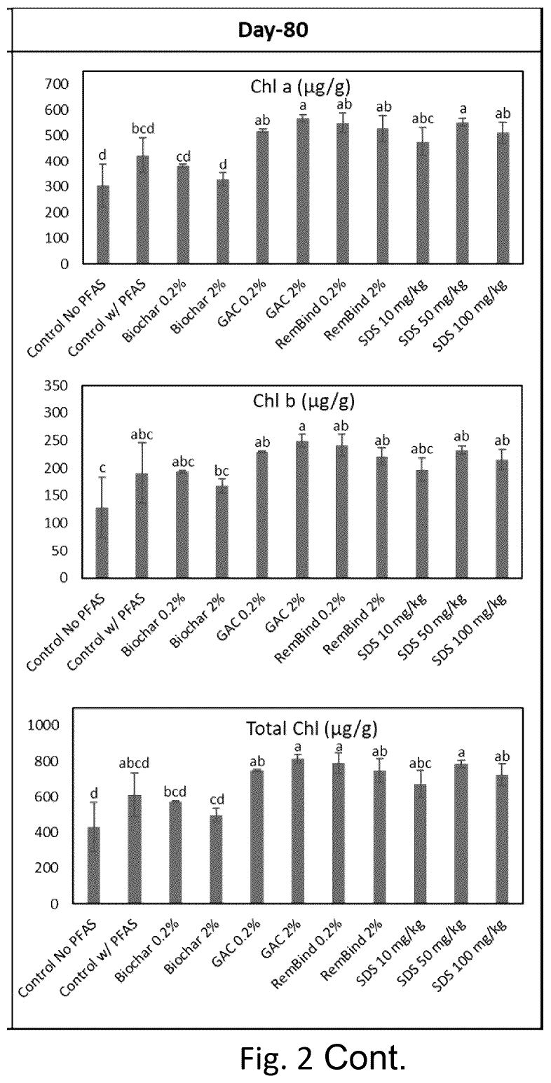

FIG. 2 is a series of graphs 24 of Levels of chlorophyll a 26, chlorophyll b 28, and total chlorophyll 30 in timothy-grass shoots on Day-40 and Day-80 (n=3). Different letters represent significant differences among the treatments (p<0.05). To investigate the effects of PFAS exposure, stabilization treatment for biosolids, and mowing on the growth of timothy-grass, the contents of chlorophyll a 26 and chlorophyll b 28 were quantified, which are the main pigments used in photosynthesis, in grass shoots on Day-40 and Day-80 (FIG. 2). The results indicated that spiking PFAS at 300 μg/kg in biosolids had no significant effect on the chlorophyll content of timothy-grass. Although GAC and RemBind resulted in significantly higher total chlorophyll content compared to the non-spiked controls on Day-80, this effect was absent when compared to the spiked controls. Eliminating the potential effect from chlorophyll content, the increased uptake of PFAS after the first cutting can be due to: 1) established root systems as a result of the first 40-day growth; 2) roots adapted to the presence of and exposure to PFAS; and 3) PFAS already accumulated in the roots. Thus, repeated cutting of the shoots will result in faster uptake of PFAS in soil and eventually lead to significant removal of PFAS from target sites. This will be beneficial from the perspective of phytoremediation. Besides the PFAS concentrations in grass shoots, the concentrations of acidic water (SPLP) leachable PFAS in soil were also determined.

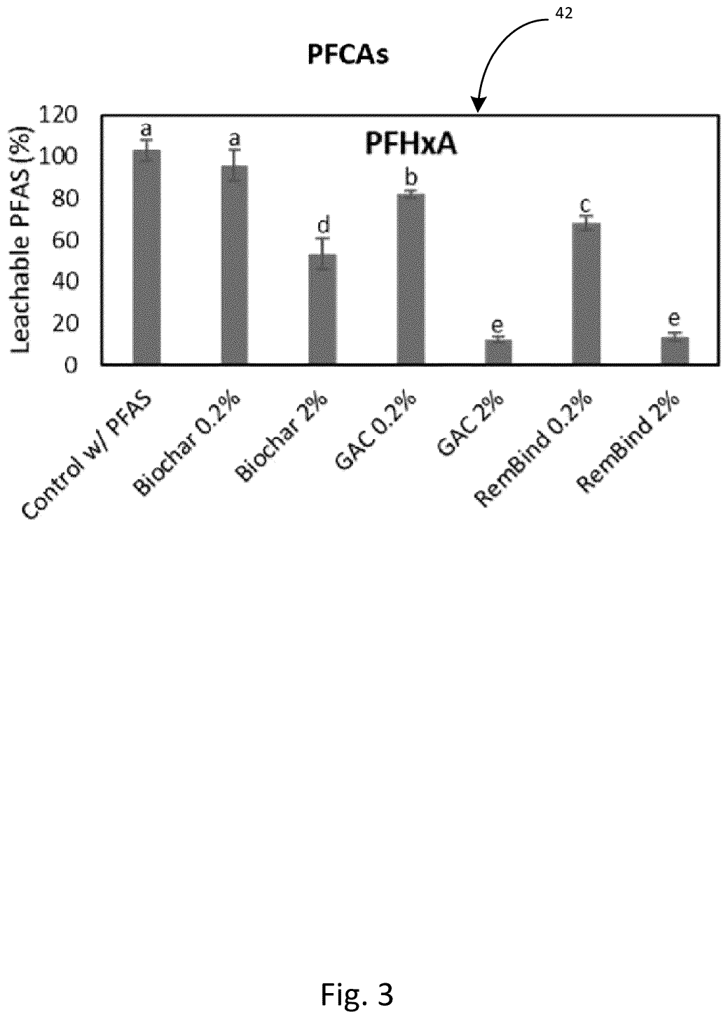

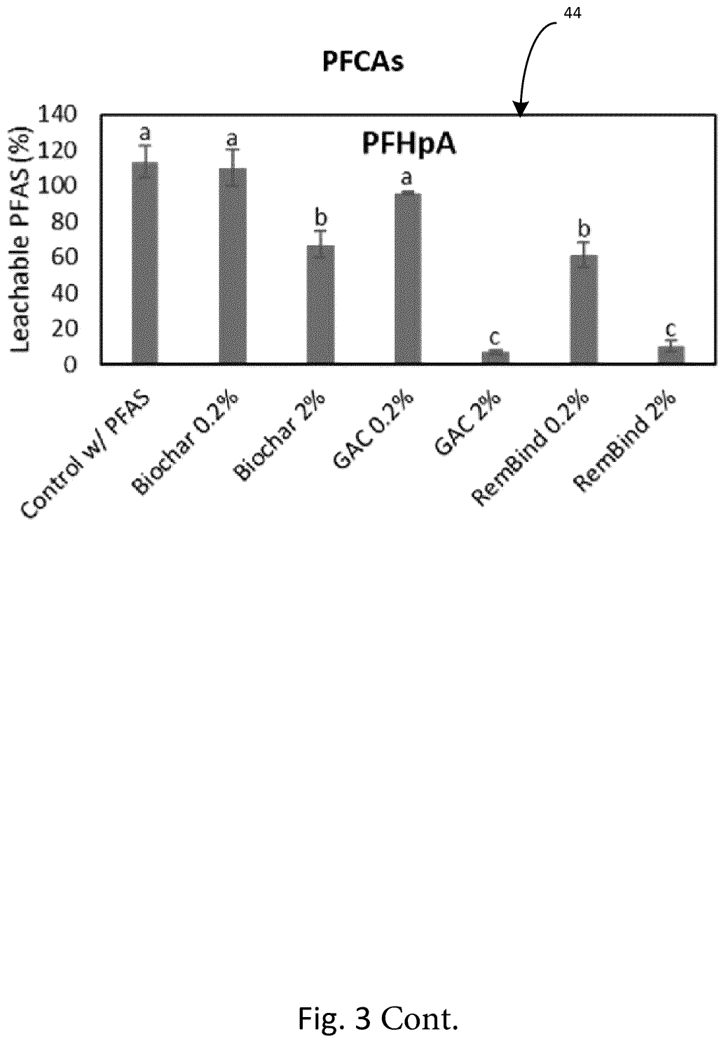

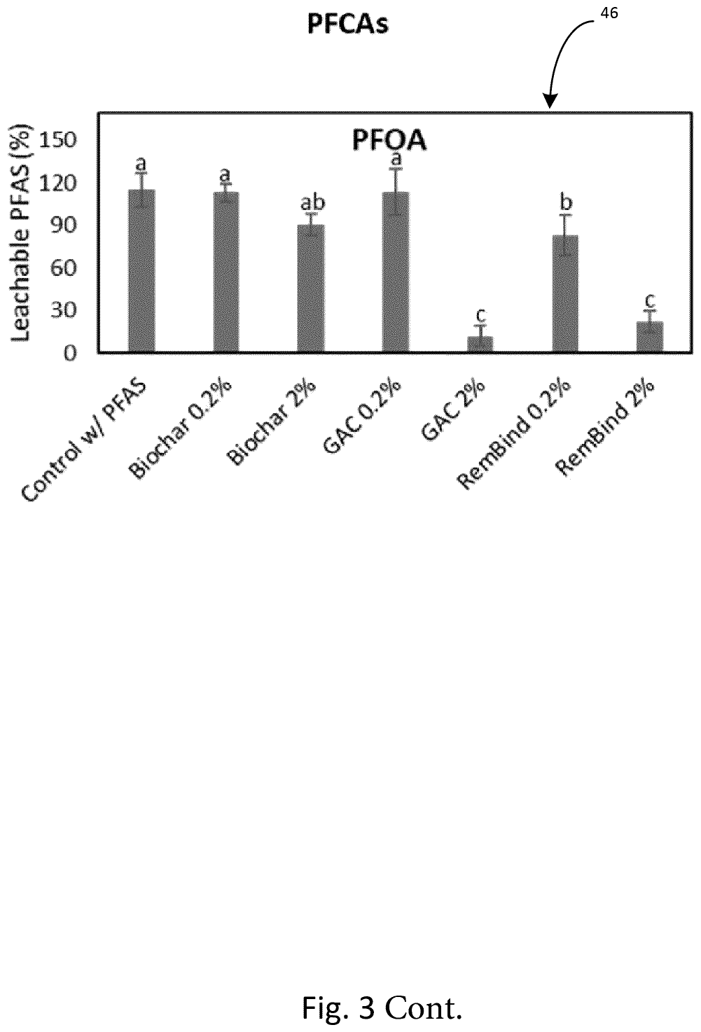

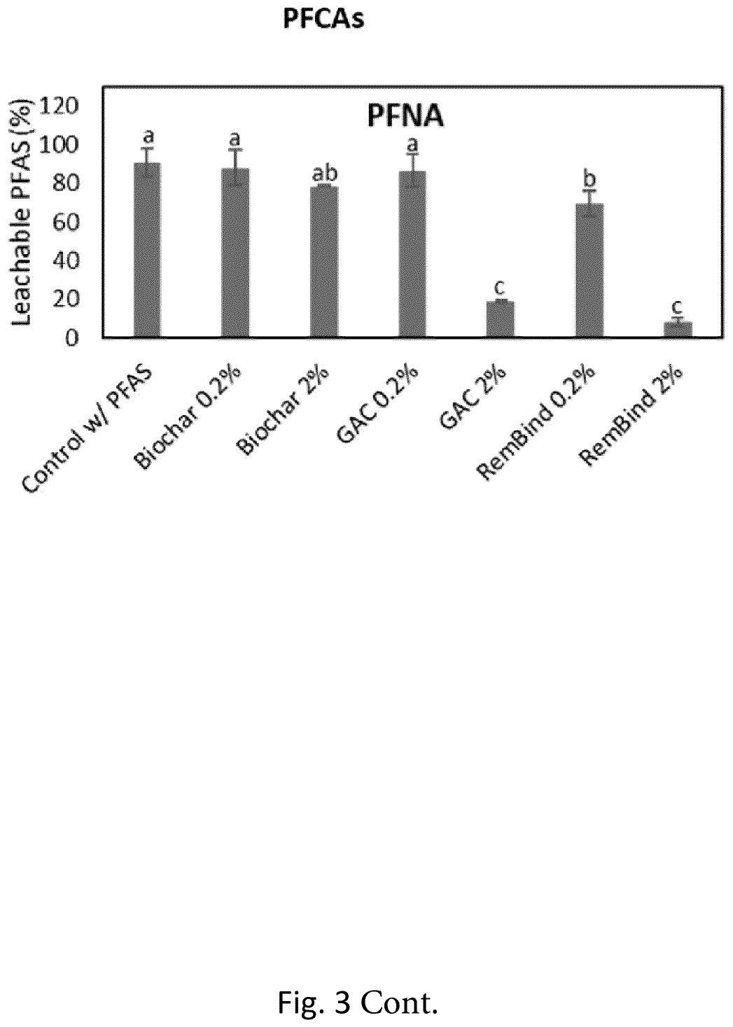

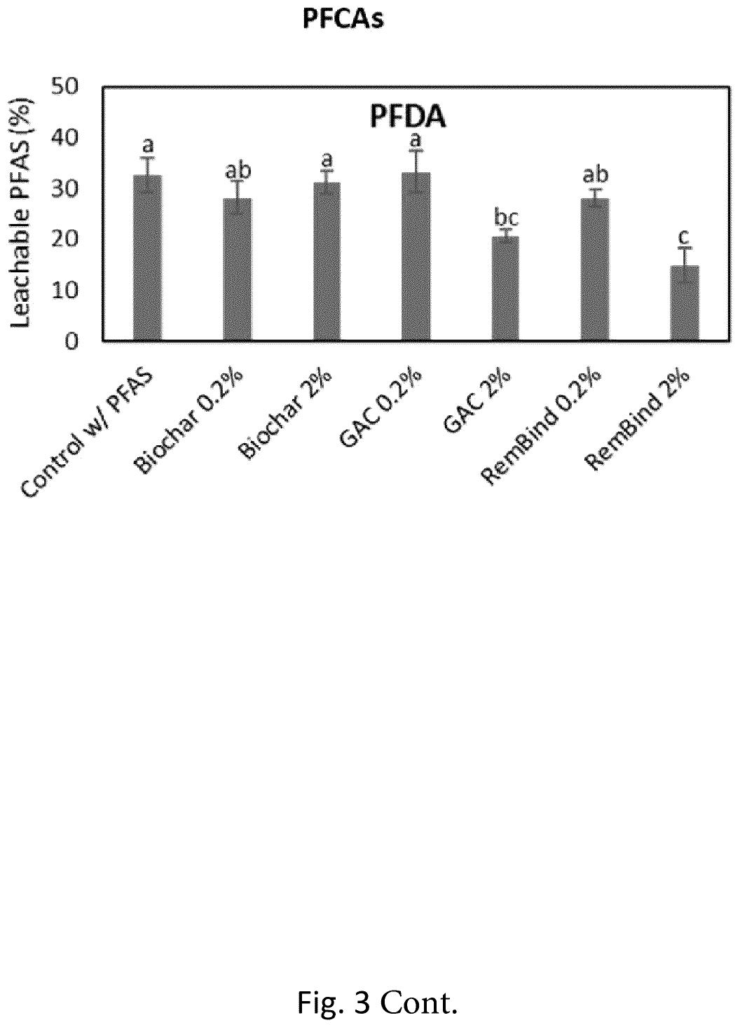

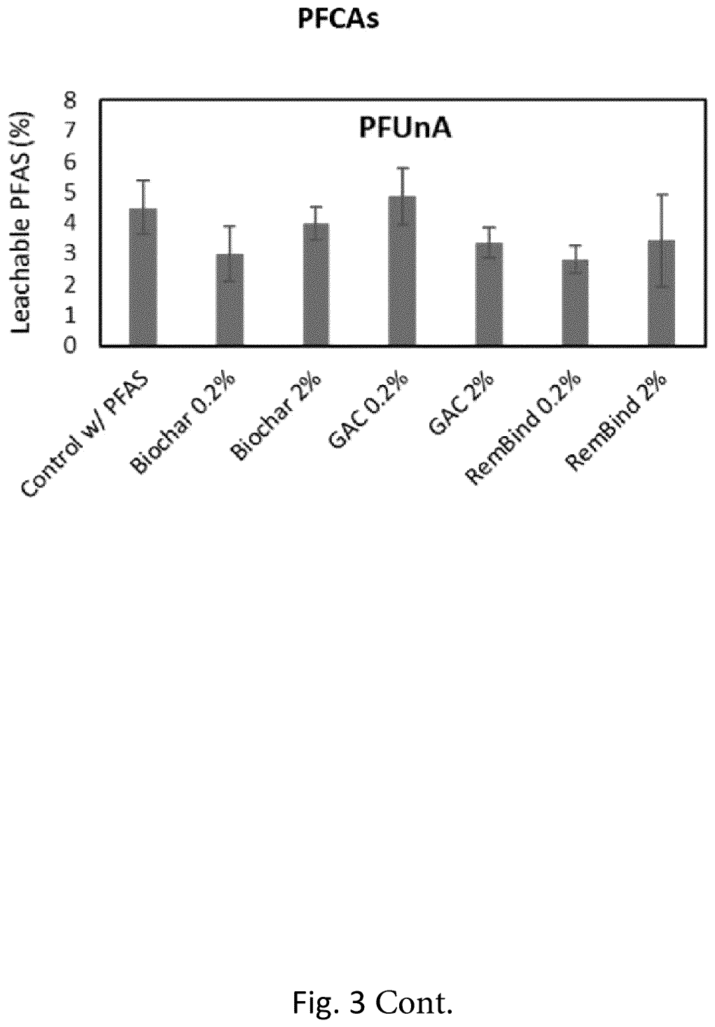

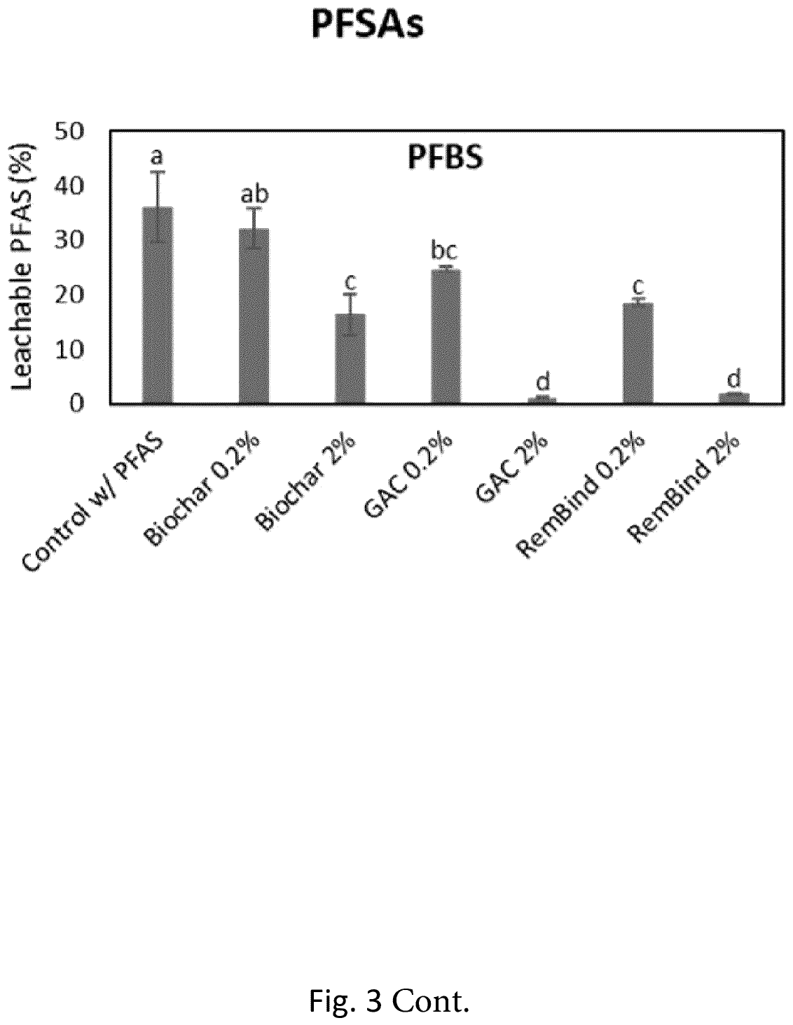

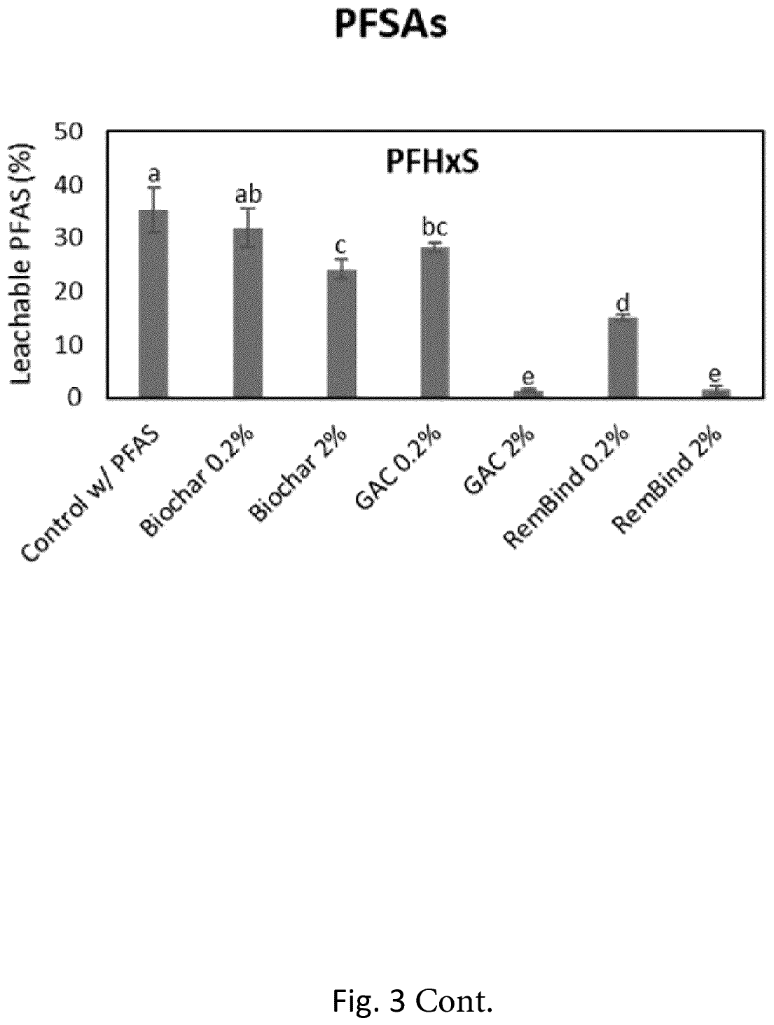

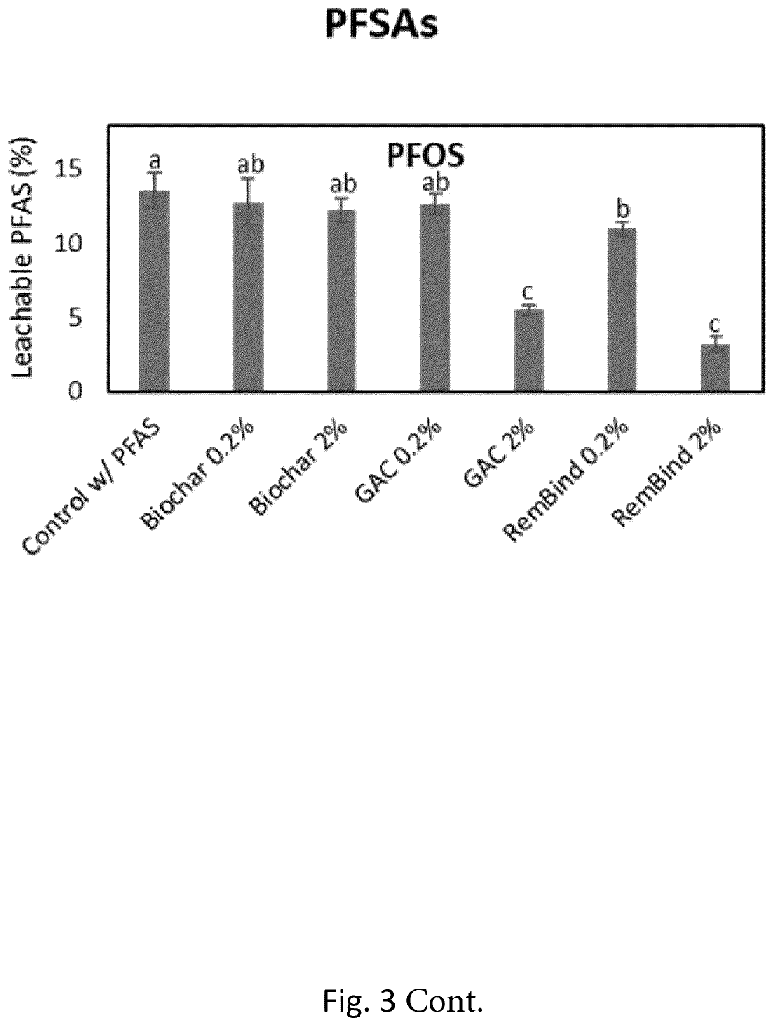

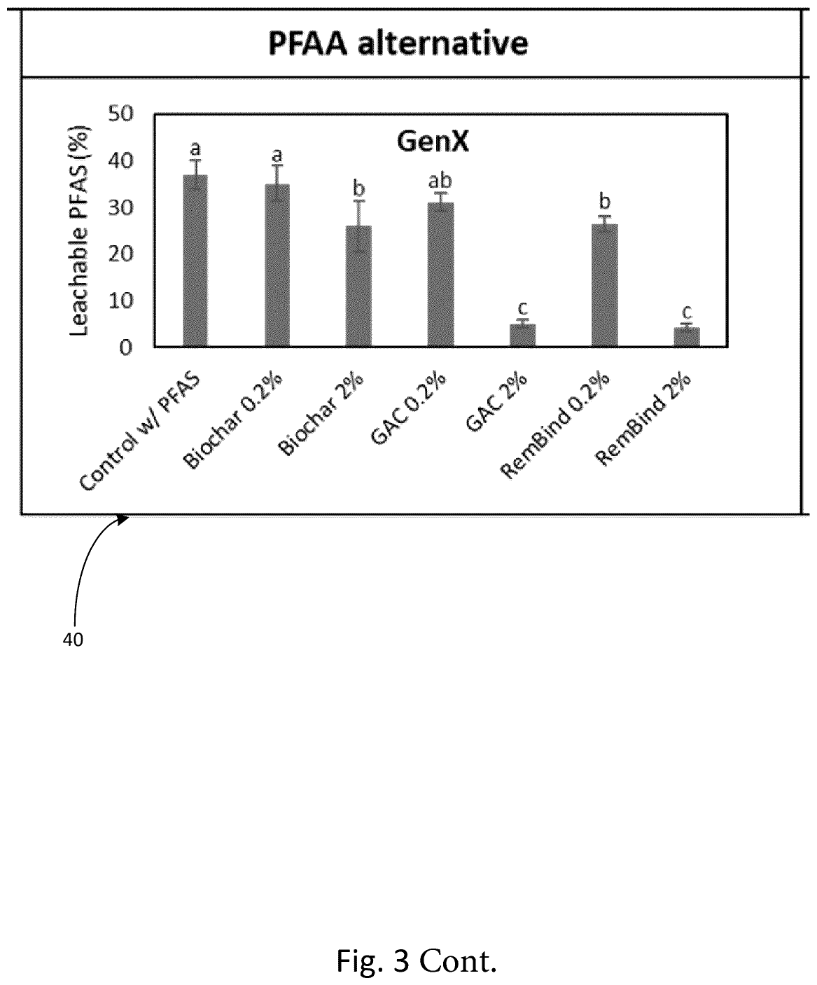

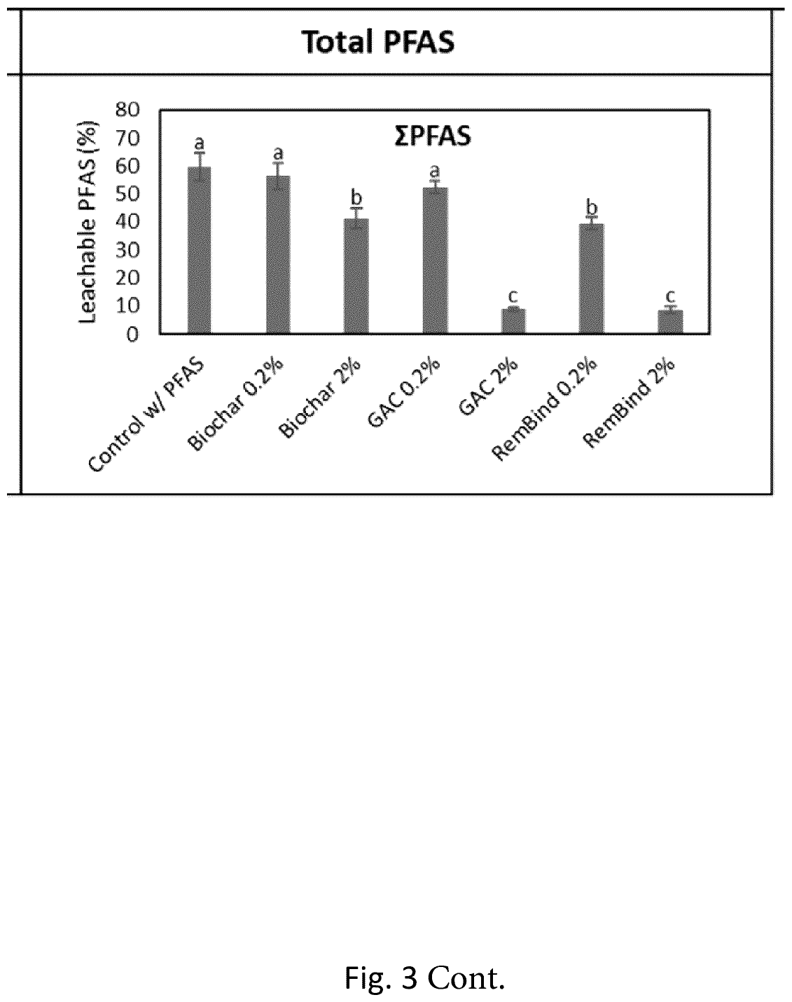

FIG. 3 is a series of graphs 40 of percentages of leachable PFAS in biosolids-amended soil treated by different sorbents on Day-80 (n=3). Different letters represent significant differences among the treatments (p<0.05). FIG. 3 shows the percentages of leachable PFAS in biosolids amended soil, which were calculated by dividing the mass of SPLP leachable PFAS by the total mass of spiked PFAS. Without a sorbent, almost 100% of leaching of PFHxA 42, PFHpA 44 and PFOA 46 was observed. Similarly to PFAS uptake by the shoots, a chain length effect was visible: the shorter the carbon chain of PFAS, the higher the leachability. Expectedly, GAC and RemBind at 2% significantly reduced the leachability of all studied PFAS, except PFUnA, in the biosolids amended soil. Interestingly, biochar at 2% and RemBind at 0.2% also resulted in significantly lower acidic water leachable PFAS, while biochar and GAC at 0.2% had no significant effect on PFAS leaching compared to the spiked controls. Compared to PFAS concentrations in the shoots (FIG. 1), there was no positive correlation between acidic water leachable PFAS and the extent of shoot uptake for treatment with biochar at both doses and RemBind at the dose of 0.2%. Thus, results from SPLP at pH=4.2 for sites east of the Mississippi River may not be able to predict bioavailable PFAS to the studied grass. The SPLP is an established and widely adopted EPA method for investigating leaching of organic contaminants in soil. One should note that the acidic water used in the leaching procedure may actually decrease PFAS leaching due to the acidic nature of PFAAs. But since the focus here was to evaluate the effect of different sorbents toward stabilizing PFAS in soil amended by biosolids, the SPLP served our purpose well.

PFAS mobilization in biosolids-amended soil partition-like interactions between nonionic portions of the surfactant and PFA leads to an increase in water solubility and a decrease in sorption. This has been observed with PFOS in the presence of an anionic surfactant, sodium dodecylbenzene sulfonate (SDBS), at 50 mg/L in an aqueous solution. Adding such surfactant increased the solubility of PFOS, resulting in decreasing sorption of PFOS on sediment and increasing mobility of PFOS. It has been reported that SDS at 100 mg/L decreased the sorption of PFOS, PFNA, and PFDA in soil.

Anionic surfactants may also form hemimicelles near a solid surface, compete for sorption sites with PFAS, and decrease the sorption of PFAS on soil. Cationic surfactant, such as cetyltrimethylammonium bromide (CTAB), however, was shown to have enhancing effect on PFAS sorption. Some found that CTAB at a concentration up to 50 mg/L remarkably enhanced the sorption of PFOS to sediment and reduced the mobility of this PFAA. This cationic surfactant was assumed to form hemimicelles coupled with PFOS and sorb on the sediment, thus decreasing PFOS mobility.

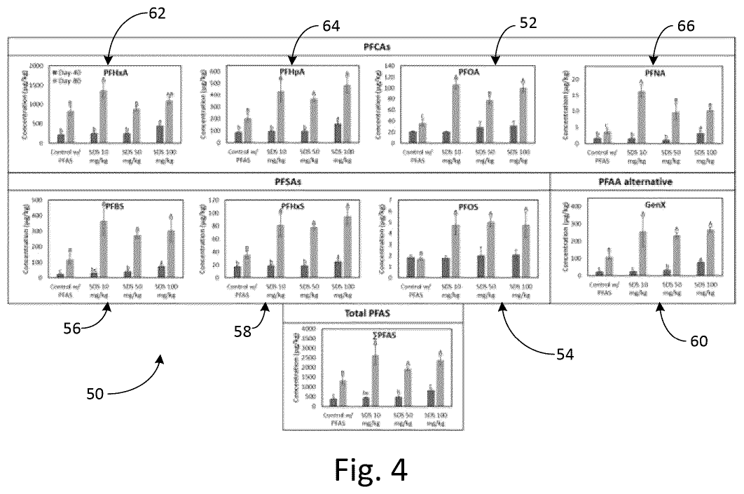

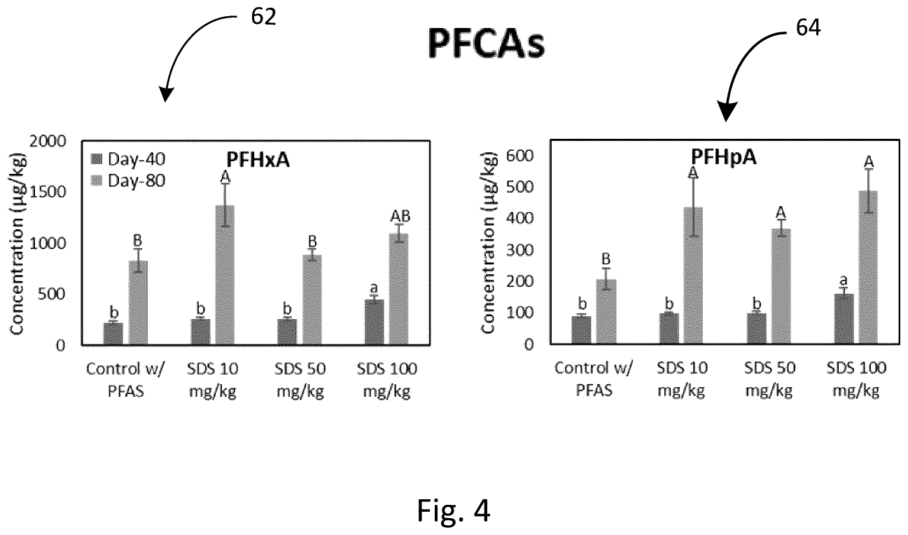

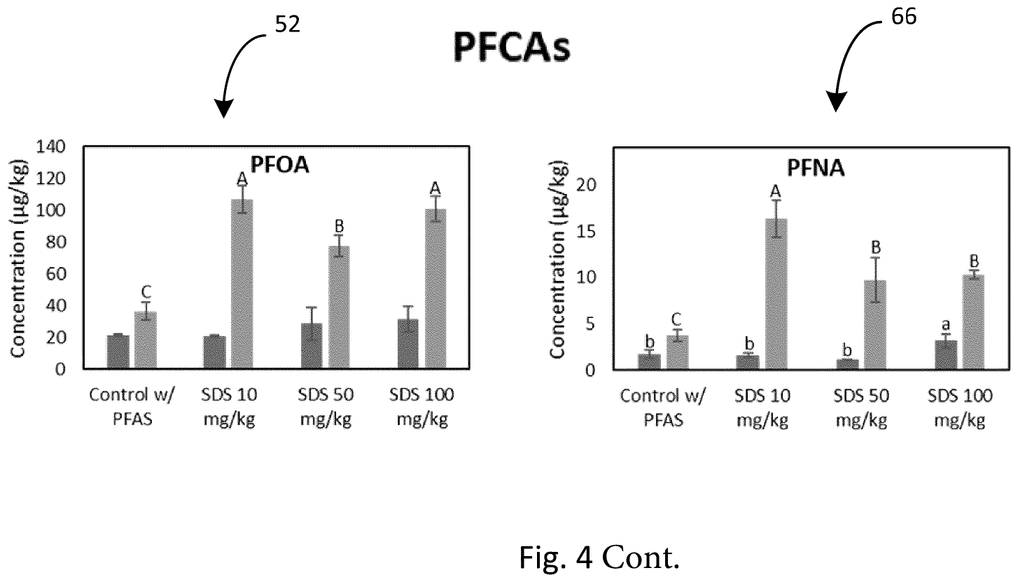

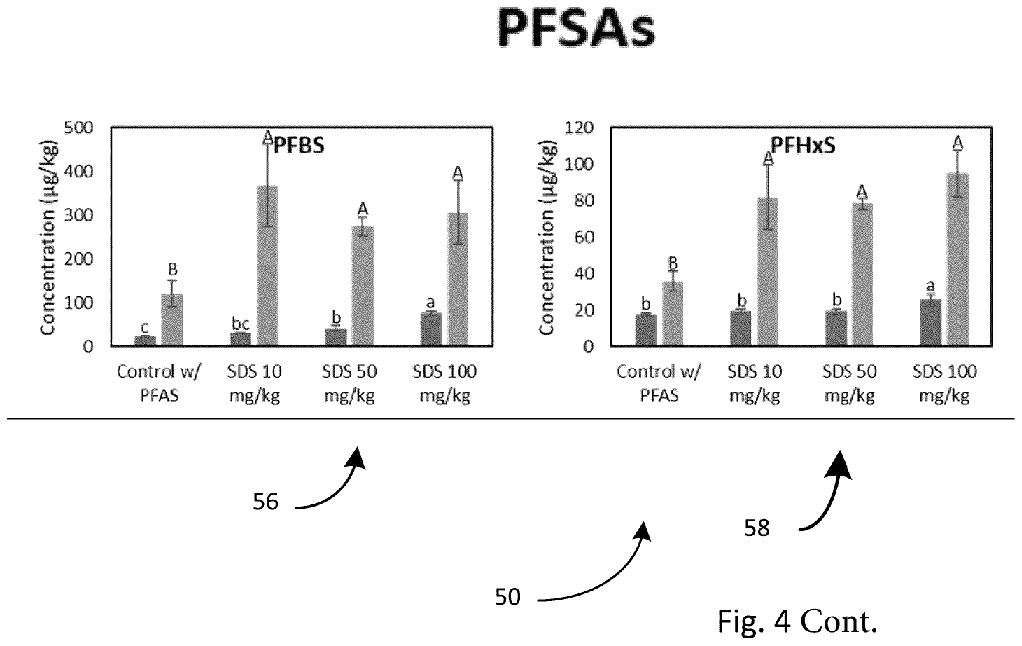

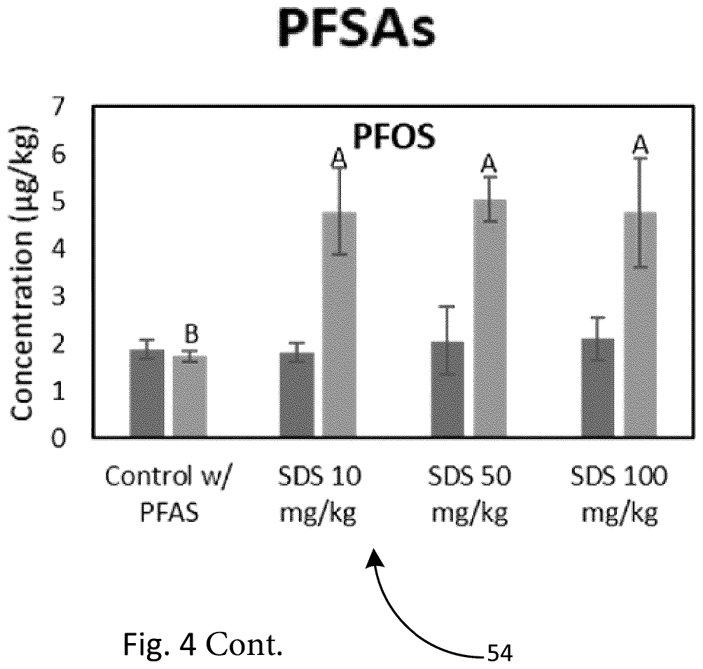

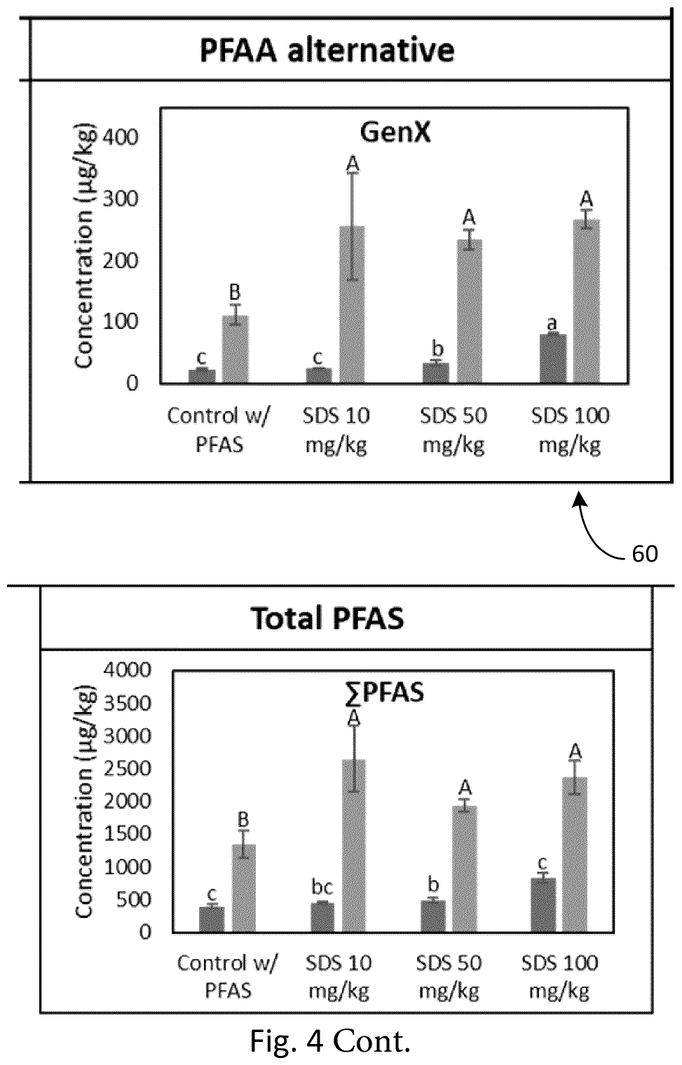

Here, although adding SDS to biosolids at a dose up to 100 mg/kg did not significantly increase acidic water leachable PFAS in the biosolids amended soil, the plant uptake of PFAS was positively affected by such surfactant treatment, as shown in FIG. 4. FIG. 4 is a series of graphs 50 of concentrations of PFAS in timothy-grass shoots grown in biosolids-amended soil treated by SDS on Day-40 and Day-80 (n=3). PFDA and PFUnA were not detected in timothy-grass shoots. Different letters in lower case and upper case represent significant differences among the treatments (p<0.05). On Day-40, only the highest dose of 100 mg/kg resulted in significantly higher uptake of PFAS by the shoots. The exceptions were PFOA 52 and PFOS 54, for which no dose effect was observed. On Day-80, however, no dose effect was visible for PFSAs as all three doses led to significantly higher uptake of PFBS 56, PFHxS, 58 and PFOS 54 by the shoots. This was also true for GenX 60.

Regarding PFCAs, the dose effect was specific to each individual PFAS. With respect to PFDA and PFUnA, SDS at ≥100 mg/kg did not lead to detection of these two long chain PFCAs in the shoots. The absence of these two PFCAs in the shoots and their low leachability by SPLP, especially for PFUnA, hinted that they may bind to biosolids and soil tightly. For ΣPFAS, all three doses led to significantly higher PFAS uptake by the shoots on Day-80. With SDS, similar effect of chain length and PFAS functional group on their uptake by the shoots as those revealed in FIG. 1 was observed. Similarly, the grass shoots accumulated more PFAS and achieved higher ΣPFAS removal during the second 40 days than those during the first 40 days. After two cuts, the total removal of ΣPFAS, which was calculated by dividing the mass of ΣPFAS in plant shoots by the total mass of ΣPFAS spiked to the biosolids, in the biosolids amended soil treated by SDS at 10, 50, and 100 mg/kg was 8.90±1.49%, 7.24±0.41%, 9.16±0.95%, respectively. Regarding individual PFAS, the uptake by shoots from soil followed this order: PFHxA 62 (46.94±6.37%)>PFHpA 64 (18.66±2.47%)>PFBS 56 (11.46±2.72)>GenX 60 (9.91±0.49%)>PFOA 52 (3.79±0.46%)≈PFHxS 58 (3.45±0.45%)>PFNA 66 (0.52±0.06%)>PFOS 54 (0.21±0.04)>PFDA (0%)=PFUnA (0%).

The mobilization treatment with SDS did not change the chlorophyll content in timothy-grass either, although shoots exposed to SDS at 50 or 100 mg/kg had higher chlorophyll content compared to the non-spiked controls on Day-40 after mowing (FIG. 2). Overall, SDS significantly increased the bioavailability of PFAS to timothy grass in biosolids amended soil. In light of the increased uptake by shoots over time, it is reasonable to expect that this treatment could be used to improve the performance of phytoremediation at PFAS contaminated sites.

In summary, PFAS in biosolids must be controlled. Without proper treatments, PFAS in the biosolids-soilplant systems will be translocated to plant shoots, are mobile and easily leached by water although the extent of upward and downward movement depends significantly on plant species and individual PFAS's physicochemical properties. In this context, there two strategies for controlling PFAS in biosolids destined for land application.

One strategy is to amend the biosolids with either GAC or RemBind at 2% to stabilize PFAS in the biosolids-soil matrix. In this case, it is expected that PFAS will become immobilized and stable in the matrix. To demonstrate the practicality of this strategy, long-term field studies are needed in view of the possibility that PFAS can desorb from the sorbent and/or the biosolids/soil particles due to microbial degradation and the dynamic nature in the real world.

Another approach is to add SDS at 10-100 mg/kg to increase PFAS bioavailability to plants. In this scenario, the rationale is to allow PFAS to be uptaken by plants to the maximum extent. The harvested plants can then be handled by a hydrothermal liquefaction process for complete PFAS destruction. Such an approach, however, could potentially lead to an uncontrolled leaching of PFAS to surrounding environments as PFAS are more mobile due to the presence of a surfactant. Therefore, the long-term effect of this strategy needs to be further evaluated in the field to justify its value.

Anionic surfactants could affect PFAS sorption in soil through Stabilization was accomplished by adding a sorbent (i.e. granular activated carbon (GAC), RemBind, biochar) to biosolids, while mobilization was achieved by adding a surfactant, sodium dodecyl sulphate (SDS), to biosolids. The impact of PFAS exposure on soybean uptake of these compounds across generations was investigated. The results showed that the exposure of the first-generation soybean to a PFAS mixture led to accumulation of perfluorobutanoic acid (PFBA, 12.20±11.44 μg/kg), perfluorohexanoic acid (PFHxA, 55.66±42.06 μg/kg), and erfluorobutanesulfonic acid (PFBS, 3.24±2.06 μg/kg) in the seeds. The progeny soybean plants grown from the first-generation seeds had a higher capability of taking up and accumulating perfluorocarboxylic acids (PFCAs), including PFBA, PFHxA, perfluoroheptanoic acid (PFHpA), and perfluorooctanoic acid (PFOA), when exposed to the same PFAS again.

In another embodiment, soybean (Glycine max (L.) Merr. cv. Tohya) was grown soil spiked with PFAS mixtures at a target concentration of 10 or 100 μg/kg, in addition to one control group without PFAS exposure, across two generations. The PFAS mixture consisted of four perfluorocarboxylic acids (PFCAs) (i.e., perfluorobutanoic acid (PFBA), perfluorohexanoic acid (PFHxA), perfluoroheptanoic acid (PFHpA), PFOA), three perfluorosulfonic acids (PFSAs) (i.e., PFBS, PFHxS, PFOS) and a PFOA alternative (i.e., undecafluoro-2-methyl-3-oxahexanoic acid (GenX)). Another two groups of plants were grown in soil spiked with individual PFOA or PFOS at 10 or 100 μg/kg. The concentrations of PFAS in plant tissues at the same growth stage across the two generations were compared. The PFAS concentrations in the seeds of soybean plants exposed to PFAS were determined as well. To our best knowledge, this is the first study reporting how PFAS-contaminated soybean seeds behave differently from the uncontaminated counterparts.

The sandy loam soil (pH=7.56) used for plant cultivation was collected from a local farm in Albany County, NY. This soil has an organic matter content of 4.82% and total organic carbon content of 2.44%. Before use, the soil was passed through a 2-mm sieve and mixed with vermiculite in a 1:1 volume ratio. The inclusion of vermiculite was to improve soil aeration and water retention. The prepared soil was then allocated to 18-fl oz disposable plastic cups. Each cup contained 170 g of dry soil. Afterwards, the stock solution of PFOA, PFOS, or PFAS mixture containing PFBA, PFHxA, PFHpA, PFOA, PFBS, PFHxS, PFOS, and GenX was added to each cup, reaching the target concentration of 10 μg/kg or 100 μg/kg for each individual PFAS. To homogenize PFAS and soil, water was further added to each cup until the soil reached 100% of field capacity. Controls without PFAS spiking were set up as well. Six replicates were prepared for each treatment and control.

The seeds of Glycine max (L.) Merr. cv. Tohya (soybean) purchased from Johnny's Selected Seeds (Winslow, ME) were placed in wet sand for germination. After 7 days, healthy seedlings were individually transferred to the cups filled with the prepared soil. The plants were then cultivated in a greenhouse and irrigated every day. The temperature and relative humidity in the greenhouse were controlled at 25-30° C. and 60-80%, respectively. Only natural sunlight was provided for plant growth. On Day-41 after germination, just before the flowering stage of the plants, three of the six replicates in each treatment and control were harvested and separated into roots and shoots. The shoots and roots after rinsing by deionized water were freeze-dried at −37° C. for 48 hours and the soil was air-dried in a fume hood for 14 days. The dried plant tissues and soil were subject to PFAS extraction and quantification. On Day-94 after germination, the remaining three plant replicates in each treatment and control reached full maturity and were harvested.

At this stage, all leaves were yellow and fell from the stems. From each mature plant, 10-20 fully developed seeds were collected. Half of the collected seeds in each treatment and control were subject to PFAS extraction and quantification and the other half were germinated in wet sand again. After 7 days of germination, healthy seedlings derived from seeds exposed to PFAS were individually transplanted to the same soil spiked with PFOA, PFOS, or a PFAS mixture at 10 μg/kg or 100 μg/kg for each individual PFAS and cultivated in the same greenhouse. Same as the first-generation, on Day-41 after germination, the second-generation soybean plants were harvested and separated into roots and shoots. Similarly, the freeze-dried plant tissues and air-dried soil were subject to PFAS extraction and quantification.

PFAS in the freeze-dried soybean shoots/roots, seeds and the air-dried soil were extracted using previously developed methods which were detailed in the Supporting Information (SI). Each sample was spiked with 10 ng of 13C2-PFHxA as the surrogate for determining the PFAS extraction efficiency. PFAS in the extracts were quantified using a 1290 Infinity II LC system coupled with a 6470 Triple Quad Mass Spectrometer (LC-MS/MS, Agilent Technologies, Santa Clara, CA). The detailed instrumental parameters were listed in the SI.

The experimental results are presented as means±the standard error of three replicates. One-way ANOVA with Duncan's post hoc tests and study tests were performed with IBM SPSS Statistics 22. Statistical significance was accepted when p<0.05.

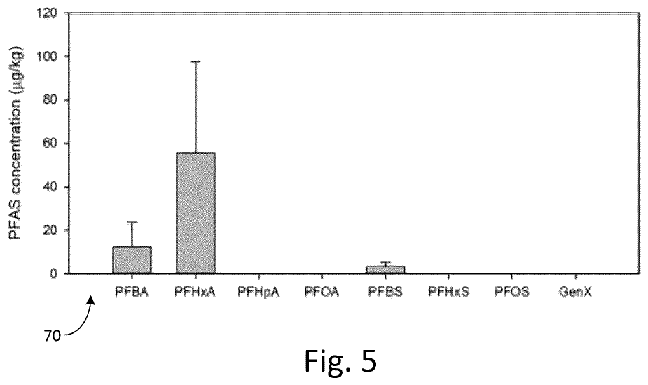

PFAS accumulation in soybean seeds was studied using the soybean seeds collected from a previous work where soybean was exposed to PFOA, PFOS or a PFAS mixture at either 10 or 100 ug/kg. At the end of that study which was referred to as the first-generation and when soybean reached the end of its reproductive stage on Day-94, we collected the seeds. The harvested seeds were then subject to PFAS extraction and quantification. Exposure to a PFAS mixture at 10 μg/kg or individual PFOA or PFOS at 10 or 100 μg/kg did not lead to any PFAS accumulation in the plant seeds, while exposure to a PFAS mixture at 100 μg/kg resulted in the detection of short chain PFAS including PFBA, PFHxA, and PFBS in the harvested seeds, as shown in FIG. 5. FIG. 5 is a graph 70 of concentrations of PFAS in the seeds of the first-generation soybean plants after 94 days of exposure to mixture at 100 μg/kg. Error bars represent standard deviations (n=3). PFHxA had the highest concentration of 55.66±42.06 μg/kg, followed by PFBA at 12.20±11.44 μg/kg and PFBS at 3.24±2.06 μg/kg.

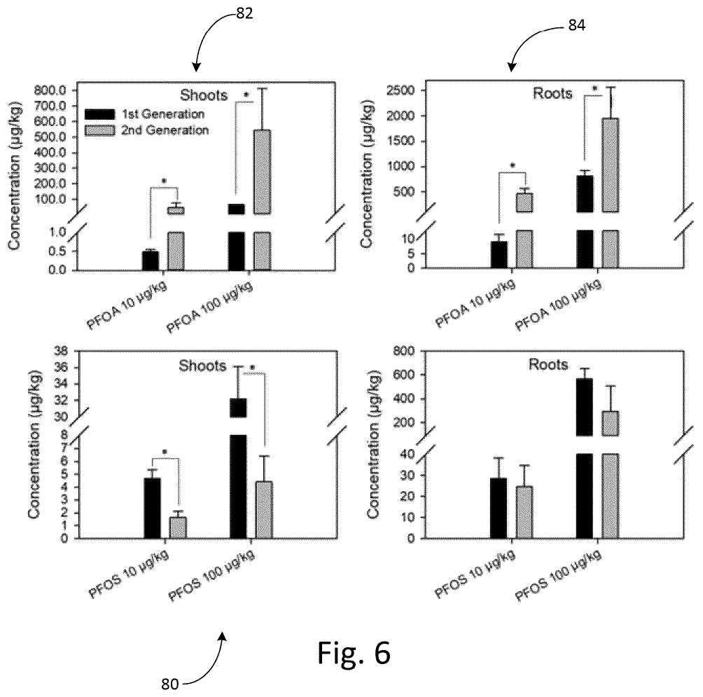

There was clear uptake of PFAS by shoots and roots of soybean grown from PFAS-containing seeds. Without PFAS spiking, all target PFAS in this study were nondetectable in the soil and control plants, indicating that the cultivation environment and the original seeds were PFAS free. FIG. 6 is a series of graphs 80 of the concentrations of PFOA or PFOS in the shoots 82 and roots 84 of the first- and second-generation soybean plants after 41 days of exposure to individual PFOA or PFOS at 10 or 100 μg/kg. Error bars represent standard deviations (n=3). Asterisks indicate significant differences between PFAS concentration in plant tissues exposed to individual spike PFOA/PFOS and PFAS mixture (Student's t-test, p<0.05). This demonstrates that plants with engineered uptake of PFAS, such as from generations of exposure and uptake, can be placed adjacent to other plants to limit their uptake of PFAS.

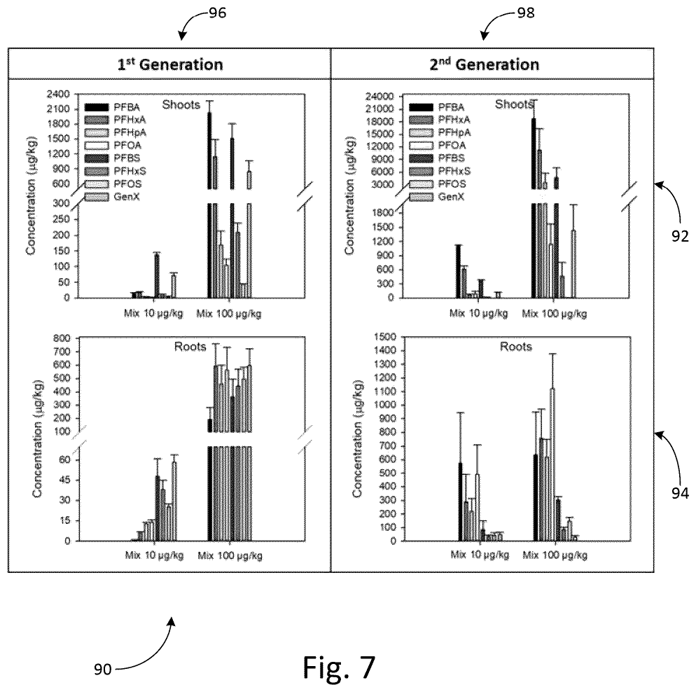

FIG. 7. Is a series of graphs 90 of concentrations of PFAS in the shoots 92 and roots 94 of the first- and second-generation soybean plants after 41 days of exposure to mixture at 10 or 100 μg/kg. Error bars represent standard deviations (n=3). As shown in FIGS. 6 and 7, after 41 days' exposure to PFAS, all PFAS were detected in the plant tissues. In general, higher PFAS concentrations were observed in soybean shoots and roots when the exposure concentrations were higher. In soybean shoots exposed to the PFAS mixture, short chain PFAS had higher concentrations than long chain counterpart. At the same time after germination (Day-41), we compared the PFAS levels in the plant tissues across two generations. Notably, the concentrations of all PFAS except PFOS in the second-generation 98 plant shoots were significantly higher than those in the first-generation 96 plant shoots. Specifically, PFOA concentration in the second-generation 98 soybean shoots exposed to PFOA only at 10 and 100 μg/kg increased by 9,452.55% and 740.76%, respectively, compared to that in the first-generation soybean shoots.

PFOS concentration in the second-generation 98 soybean shoots exposed to only PFOS at 10 and 100 μg/kg decreased by 55.77% and 84.83%, respectively (FIG. 6). When exposed to a PFAS mixture at 10 μg/kg, the uptake by the second-generation shoots, when compared to those from the first generation, increased the most for PFBA by 7,446.27%, followed by PFOA (3,858.54%), PFHxA (3,472.94%), and PFHpA (1,387.94%) (FIG. 7). The uptake increase of PFSAs in plant shoots across the two generations were relatively lower than those of PFCAs. The uptake of PFBS and PFHxS increased by 173.13% and 30.44%, respectively. Furthermore, the second-generation soybean shoots took up 64.09% more of GenX compared to the first-generation plants. At the exposure concentration of 100 μg/kg, a similar trend was observed that the second-generation shoots accumulated more PFAS than the first generation shoots and the uptake increase of PFCAs across the two generations was higher than those of PFSAs.

Regarding the PFAS concentrations in plant roots, the second generation soybean plants exposed to individual PFOA still had significantly higher PFOA concentration than the first-generation plants (FIG. 6). For those exposed to a PFAS mixture, the second-generation soybean roots also had higher concentrations of PFCAs than those in the first-generation roots (FIG. 7). However, at the exposure concentration of 10 μg/kg, PFHxS and GenX in the second-generation soybean roots decreased by 17.18% and 20.61%, respectively, compared to that in the first-generation soybean plants. At the exposure concentration of 100 μg/kg, the uptake of PFBS, PFHxS, and PFOS by the second-generation soybean roots decreased by 17.04%, 80.83%, and 70.45%, respectively. The concentration of GenX in the second-generation soybean roots also decreased by 94.80% compared to that in the first-generation soybean roots.

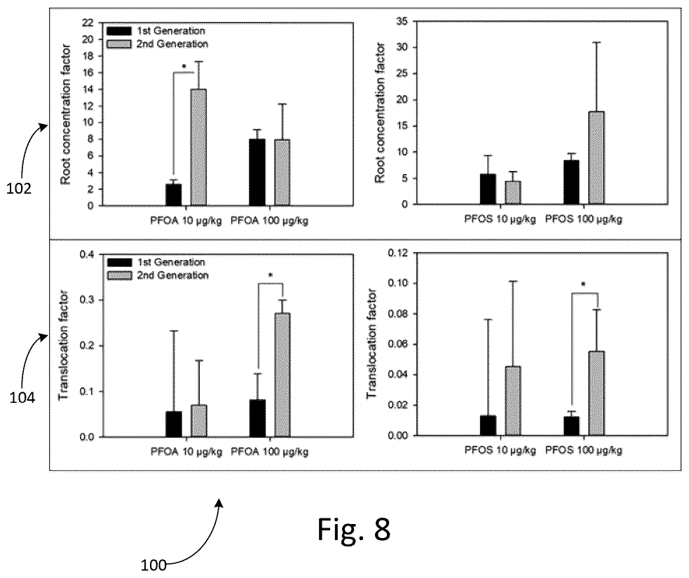

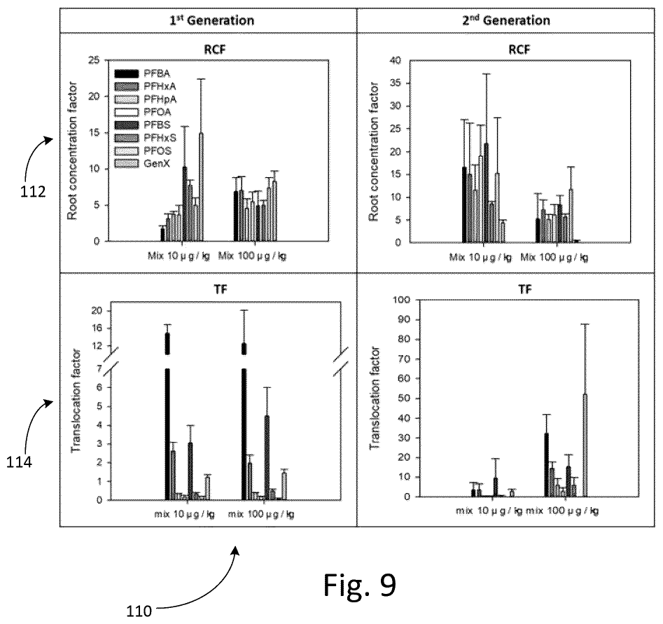

The root concentration factors (RCFs) of PFAS, which were calculated by dividing the concentration of PFAS in root tissues by their corresponding concentration in the soil, were shown in FIGS. 8 and 9. FIG. 8 is a series of graphs 100 of root concentration factors (RCF) 102 and translocation factors (TF) 104 of PFOA or PFOS in first- and second-generation plants after 41 days of exposure to individual PFOA or PFOS at 10 μg/kg or 100 μg/kg. Error bars represent standard deviations (n=3). Asterisks indicate significant differences between PFAS concentration in plant tissues exposed to individual spike PFOA/PFOS and PFAS mixture (Student's t-test, p<0.05).

FIG. 9 is a series of graphs 110 of root concentration factors (RCF) 112 and translocation factors (TF) 114 of PFAS in first- and second-generation plants after 41 days of exposure to PFAS mixture at 10 μg/kg or 100 μg/kg. Error bars represent standard deviations (n=3). In general, RCFs of PFAS except GenX in the second-generation soybean exposed to PFAS at 10 μg/kg were significantly higher than those in the first-generation soybean. At the exposure concentration of 100 μg/kg, RCFs of PFAS except GenX in two generations of soybean plants were comparable. RCF of GenX in the second-generation soybean was significantly lower than that in the first-generation soybean, regardless of the exposure concentration. The bioconcentration factors (BCFs) of PFAS were also calculated by dividing the concentration of PFAS in shoot tissues by their corresponding concentration in the soil. BCFs of PFAS except PFOS and GenX in the second-generation soybean exposed to PFAS at 10 μg/kg were significantly higher than those in the first-generation soybean. Similarly, at the exposure concentration of 100 μg/kg, BCFs of PFAS except PFOS in the second-generation soybean were significantly higher than those in the first-generation soybean. The translocation factors (TFs) of PFAS, which were the ratio of

PFAS concentration in the shoots to that in the roots, decreased with increasing carbon chain length in both generations of soybean plants (FIG. 9). At the exposure concentration of 100 μg/kg, the TFs of PFAS in the second-generation plants were significantly higher than that in the first-generation plants. GenX, which has been widely used as an alternative to PFOA, had higher concentration in plant tissues and higher values of TF compared to PFOA at the same spiked concentration in both generations of the soybean. The exact values and percentage changes of RCFs, BCFs, and TFs in different treatments over two generations.

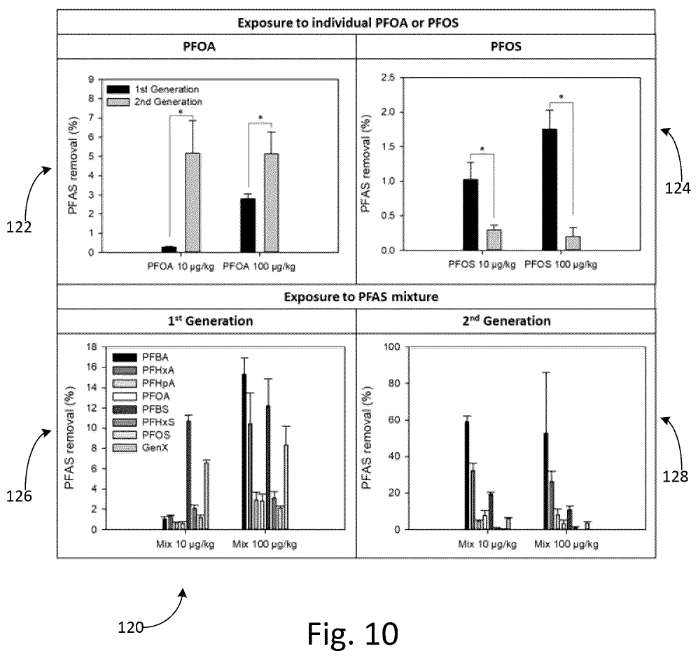

The removal percentages of PFAS on Day-41 after germination, which were calculated by dividing the sum of PFAS mass in plant shoots and roots by the total mass of PFAS added to soil, were compared between the two generations of soybean, as shown in FIG. 10. FIG. 10 is a series of graphs 120 of the percentages of PFAS removal from soil by first-generation 126 and second-generation 128 soybean plants after 41 days of exposure to individual PFOA 122, PFOS 124, or PFAS mixture at 10 μg/kg or 100 μg/kg. Error bars represent standard deviations (n=3). Asterisks indicate significant differences between PFAS concentration in plant tissues exposed to individual spike PFOA/PFOS and PFAS mixture (t-test, p<0.05).

The second-generation soybean plants exposed to individual PFOA at 10 and 100 μg/kg had significantly higher removal than the first-generation, increasing by 1,748.65% and 39.02%, respectively. In contrast, the removal percentages of PFOS by the second-generation exposed to individual PFOS at 10 and 100 μg/kg decreased by 71.13% and 88.77%, respectively, compared to that in the first-generation plants. For the soybean plants exposed to a PFAS mixture, basically, the removal was significantly higher for PFAS with shorter carbon chain (i.e., PFBA, PFHxA, PFBS, GenX) than for PFAS with longer carbon chain (i.e., PFHpA, PFOA, PFHxS, PFOS). This observation was the same for both generations. When comparing the two generations exposed to a PFAS mixture, the second-generation 128 soybean had significantly higher removal of PFCAs than the first-generation 126, regardless of the exposure concentration. PFBA had the highest increase in removal percentage, from 1.02% and 15.33% to 59.16% and 52.66% across the two generations at the exposure concentration of 10 and 100 μg/kg, respectively. PFHxA was the second. With a PFAS mixture at 10 μg/kg, the second-generation soybean removed 32.39% of this compound. This is significantly higher than 1.34% observed for the first-generation of soybean. Similar observation was also detected for PFBS. The second-generation removed 19.33% vs. 10.68% calculated for the first-generation. Between the two spiked concentrations of 10 and 100 μg/kg, no statistically significant difference was observed. Removal of the other PFSAs and GenX, however, decreased significantly by the second-generation soybean.

By visual observation, the growth and biomass of the two generations of soybean plants did not appear to be affected negatively under different PFAS exposure conditions. But the results did indicate that the exposure of the first-generation plants to PFAS led to the accumulation of short chain PFAS in soybean seeds and changed the PFAS uptake behavior of the second-generation plants. Long chain PFAS were not detected in the first-generation seeds possibly due to their low upward translocation to the shoots. It has been reported that irrigation with PFAS (C4-C8) contaminated water resulted in the accumulation of short chain PFBA at a concentration of up to 20 μg/kg in the seed part of bean, corn, pea, and peapod, demonstrating the accumulation tendency of short chain PFAS in plant seeds. PFBA, PFHxA, and PFBS have shown toxic effects on animals and humans. As the main edible part of soybean plants, seeds would eventually transfer the accumulated PFAS to consumers via the food chain, posing risks to the ecosystems.

Apparently, the exposure of the first-generation soybean to PFAS caused significant changes in their uptake by the second-generation. The progeny soybean plants grown from the PFAS-containing seeds showed a significantly higher capability of taking up and accumulating PFCAs (i.e., PFBA, PFHxA, PFHpA, PFOA) and PFBS (at the exposure concentration of 10 μg/kg) when exposed to the same group of PFAS again.

As shown in Table 2 below, there is a positive correlation between what PFAS were in the seeds and what PFAS were removed the most by the second-generation soybean.

TABLE 2
Relationship between PFAS in soybean seeds and PFAS
removal by second-generation soybean plants (n = 3)
Exposure condition: PFAS mixture at 100 μg/kg

| | PFBA | PFHxA | PFBS | PFHpA |
|---|---|---|---|---|
| PFAS concentration in seeds (μg/kg) | 12.20 ± 11.44 | 55.66 ± 42.06 | 3.25 ± 2.05 | 0 |
| PFAS removal by 2nd generation plants (%) | 52.66 ± 33.50 | 26.37 ± 5.67 | 10.89 ± 2.08 | 7.93 ± 3.35 |

| | PFOA | PFHxS | PFOS | GenX |
|---|---|---|---|---|
| PFAS concentration in seeds (μg/kg) | 0 | 0 | 0 | 0 |
| PFAS removal by 2nd generation plants (%) | 3.34 ± 1.80 | 1.07 ± 0.44 | 0.10 ± 0.01 | 3.44 ± 0.97 |

The significantly enhanced uptake of these PFAS by the plants whose parental generation was affected by PFAS exposure is encouraging from the perspective of phytoremediation. The increased removal percentages of PFCAs and PFBS by the second-generation soybean plants (FIG. 6) would significantly improve the long-term phytoremediation performance at PFAS contaminated sites. Whether this is true or not for other plant species awaits to be verified.

However, the higher accumulation capability of the second-generation soybean for certain PFAS raises serious concerns over food safety. In this study, limited number of seeds harvested from the first generation prevented us from collecting the seeds from the second generation since all triplicates of soybean were harvested before the flowering stage. Thus, the concentrations and the types of PFAS in the second-generation seeds remain unclear at this point. Based on significantly increased PFAS concentrations in the soybean shoots and roots, however, it is reasonable to expect higher concentrations of PFAS in the seeds. Unintentional use of these seeds will inevitably lead to further accumulation of PFAS and other unknown consequences.

Therefore, careful evaluations that extend two generations of soybean are necessary to obtain a holistic understanding on the long-term impact of PFAS. Contrary to PFCAs and PFBS, the second-generation soybean plants had a decreased uptake of PFHxS and PFOS compared to the first generation. The diminished uptake of the two PFSAs may imply the development of uptake resistance to this group of PFAS over generations of soybean. Our results indicated that the TFs of PFAS decreased with increasing carbon chain length of PFAS for both generations of soybean, which means short chain PFAS were more readily to be translocated to plant shoots. A previous report showed that the upward translocation of organic contaminants to above ground tissues is negatively correlated with their hydrophobicity. Generally, increasing carbon chain length of PFAS is associated with increasing hydrophobicity. Thus, short chain PFAS with lower hydrophobicity had higher TFs than long chain PFAS, which is consistent with our observation in this study. Notably, TFs of PFAS except PFOS observed for the second-generation soybean exposed to these compounds at 100 μg/kg were significantly higher than those for the first-generation soybean, indicating a facilitated translocation pathway for PFAS within plants in the second-generation soybean. Further in-depth studies on plant physiology and biochemistry are required to explore and explain the enhanced translocation of PFAS within the second-generation soybean plants.

Currently, GenX is widely used as an alternative to PFOA in the process of making high-performance polymers for manufacturing cables, cookware, non-stick coatings, etc. Its occurrence in environmental matrices has been reported worldwide. Although previous studies have shown the toxicity of GenX to animals and humans, the lifetime health advisory level was finally set at 10 ppt by the U.S. EPA in June of 2022.

This level is much higher than 0.004 ppt for PFOA. In the present study, GenX had much lower RCF, but much higher BCF and TF than those of PFOA. Combing these factors together, the removal percentage of GenX was similar to that of PFOA by the second-generation plants at both spiked concentrations (Table 2). Compared to PFOA, the shorter carbon chain of GenX makes it more hydrophilic, leading to a higher bioavailability of GenX in soil theoretically. The lower RCF could hint difficulties in passing through the root cell wall and membrane compared to PFOA. The structure of GenX could also contribute to its higher TF in plant tissues. Some have reported that the translocation potentials of branched PFOA and PFOS isomers were higher than those of linear isomers due to the higher hydrophilicity of the former. Thus, the branched structure of GenX may also facilitate its transport within soybean tissues.

Compared to the soybean plants exposed to individual PFOA or PFOS, the plants exposed to a PFAS mixture had different PFAS uptake behavior (FIGS. 8 and 9). The presence of the PFAS mixture in soil increased RCF, BCF, TF, and removal percentage of PFOA at the exposure concentration of 10 μg/kg for both generations of plants. This signaled enhanced uptake of PFOA by the presence of co-contaminants. At the exposure concentration of 100 μg/kg, the presence of the other PFAS also increased BCF and TF of PFOA but suppressed its RCF. The removal percentage of PFOA was not affected by the co-existence of the other PFAS. This may indicate that the enhancement effect of co-contaminants was offset by the high concentration of PFAS at a total of 800 μg/kg. The lower RCF could hint negative effects of PFAS at high concentrations to the root structures. Once PFAS were transferred to the roots, the upward transfer represented by BCF and TF still benefited from the presence of the other PFAS. Regarding PFOS, the presence of other PFAS in the mixture significantly increased its RCF in the second-generation plants when each PFAS was spiked at 10 μg/kg. This is reasonable to expect given the fact that PFOS is the most hydrophobic among the target eight and the other PFAS could facilitate its transport from soil to roots. The BCF, TF and removal percentage of PFOS by the second-generation soybean, however, were all less than those observed in the first generation. This is true for both spiked concentrations.

In the environment, PFAS seldom exist as individual compounds. The exception could be those contaminated by an industry process utilizing only a limited and known number of PFAS. The presence of PFAS as a mixture in the environment deepens the complexity in remediation efforts. As discussed above, the co-existence of other PFAS could affect an individual PFAS' translocation and distribution in a natural or engineered system. Depending on each PFAS' concentration and physicochemical properties, the effect could be enhancing or suppressing.

In summary, differential uptake of PFAS by soybean grown from PFAS-containing seeds can be controlled. Depending on the specific types of PFAS in the seeds already, and each PFAS' physicochemical properties, the translocation of PFAS from soil to roots and then roots to shoots varied significantly. Complete understanding of the observations and results from this study will require detailed investigations of soybean's physiology responding to PFAS exposure. Given the ubiquitous nature of PFAS in the environment and the possible use of PFAS contaminated soybean seeds in agriculture unintentionally, the advantages and usage of the present invention should be readily apparent.

The corresponding structures, materials, acts, and equivalents of all means or step plus function elements in the claims below, if any, are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of one or more aspects of the invention and the practical application, and to enable others of ordinary skill in the art to understand one or more aspects of the invention for various embodiments with various modifications as are suited to the particular use contemplated.

What is claimed is:

1. A method for enhanced phytoremediation by changing bioavailability of per- and polyfluoroalkyl substances (PFAS) to plants in amended soil, comprising:
adding a mobilizing reagent, at a predetermined dose, to amend the soil around a root system of one or more plants;
supplementing the amended soil with a stabilizing reagent at a predetermined dose; and
changing the bioavailability of (PFAS) to the one or more plants.

2. The method of claim 1, further comprising planting seeds harvested from a plant exposed to PFAS into the amended soil adjacent to the one or more plants.

3. The method of claim 2, wherein planting seeds is planting soybean seeds.

4. The method of claim 1, wherein changing the bioavailability is limiting an uptake of PFAS in the one or more plants.

5. The method of claim 1, wherein the mobilizing reagent is a surfactant.

6. The method of claim 5, wherein the surfactant is sodium dodecyl sulphate.

7. The method of claim 1, wherein the stabilizing reagent is a sorbent

8. The method of claim 7, wherein supplementing with the sorbent increases an uptake of PFAS in the one or more plants.

9. The method of claim 7, wherein the stabilizing reagent is one or more of: Biochar, granular activated carbon (GAC), and clay minerals.

10. A method for enhanced removal of per- and polyfluoroalkyl substances (PFAS) from with phytoremediation by plants, comprising:
planting seeds in PFAS-containing soil, the seeds germinating into one or more plants;
adding a mobilizing reagent, at a predetermined dose, to amend the soil around a root system of the one or more plants; and
increasing an uptake of (PFAS) to the one or more plants.

11. The method of claim 10, further comprising planting seeds harvested from a plant exposed to PFAS into the amended soil adjacent to the one or more plants.

12. The method of claim 11, wherein planting seeds is planting soybean seeds.

13. The method of claim 10, wherein the mobilizing reagent is a surfactant.

14. The method of claim 13, wherein the surfactant is sodium dodecyl sulphate.

15. The method of claim 10, further adding a stabilizing reagent to the PFAS-containing soil.

16. A method for enhanced stabilization of per- and polyfluoroalkyl substances (PFAS) in a soil to limit uptake by plants, comprising:
adding a stabilizing reagent, at a predetermined dose, to amend PFAS-containing soil around a root system of one or more plants; and
decreasing the uptake of PFAS to the one or more plants.

17. The method of claim 16, further comprising planting soybean seeds harvested from a plant exposed to PFAS into the amended soil adjacent to the one or more plants.

18. The method of claim 16, wherein the stabilizing reagent is a sorbent

19. The method of claim 18, wherein the stabilizing reagent is one or more of: Biochar, granular activated carbon (GAC), and clay minerals.

20. The method of claim 16, wherein the one or more plants are soybean plants.
